(19) United States
(12) Patent Application Publication
(10) Pub. No.: US 2025/0162323 A1
(43) Pub. Date: May 22, 2025

(54) LIQUID DISCHARGE HEAD

(71) Applicant: CANON KABUSHIKI KAISHA, Tokyo (JP)

(72) Inventors: SATOSHI IDETA, Kanagawa (JP); KYOSUKE TODA, Kanagawa (JP); YASUAKI KITAYAMA, Kanagawa (JP)

(21) Appl. No.: 18/943,667

(22) Filed: Nov. 11, 2024

(30) Foreign Application Priority Data
Nov. 16, 2023 (JP) 2023-195027
Aug. 27, 2024 (JP) 2024-145896

(51) Int. Cl. B41J 2/175

(52) U.S. Cl. CPC B41J 2/17513; B41J 2/17596

(57) ABSTRACT

The distribution flow paths each include a first opening located on the discharge element substrate side, and a second opening located on an opposite side of the first opening. In a predetermined direction, an opening width of the first opening is larger than an opening width of the second opening, and a center of the opening width of the second opening is biased to one side with respect to a center of the opening width of the first opening. At least one bend portion is formed on an inner wall of the distribution flow path located on the one side. In a use state of the liquid discharge head, a bend portion closest to the first opening among the at least one bend portion is located on an opening side of a center portion of the distribution flow paths in a vertical direction.

### BACKGROUND OF THE DISCLOSURE

### Field of the Disclosure

The present disclosure relates to a liquid discharge head.

### Description of the Related Art

A liquid discharge head for discharging liquid is mounted on a liquid discharge apparatus, and the liquid discharge apparatus achieves a desired purpose by discharging liquid. For example, in an inkjet recording apparatus, an inkjet recording head that is a liquid discharge head is mounted on a carriage, and the inkjet recording apparatus records an image or a character on a recording target medium by discharging ink from a discharge element substrate included in the inkjet recording head. The discharge element substrate is supported by a supporting member. Liquid, flowing through a narrow flow path from a flow path member upstream of the discharge element substrate, is distributed, by a distribution flow path formed in the supporting member, into a plurality of pressure chambers in which a pressure acts on liquid to be discharged from discharge ports.

Japanese Patent Application Laid-Open No. 2003-312006 discusses a liquid discharge head in which a distribution flow path is formed in a supporting member, and a first opening located on a discharge element substrate side and having a large opening width and a second opening located on the opposite side of the first opening and having a small opening width are formed in the distribution flow path. Further, Japanese Patent Application Laid-Open No. 2003-312006 discusses the fact that the center of the opening width of the second opening is biased to one side in a predetermined direction with respect to the center of the opening width of the first opening. In the liquid discharge head discussed in Japanese Patent Application Laid-Open No. 2003-312006, the center of the opening width of the second opening is biased with respect to the center of the opening width of the first opening, whereby variation occurs in the flow speeds of liquid flowing through the distribution flow path. Among inner walls of the distribution flow path, an inner wall on the side where the center of the opening width of the second opening is biased with respect to the center of the opening width of the first opening is a first inner wall, and an inner wall opposed to the first inner wall is a second inner wall. At this time, the flow speed of liquid flowing through a region close to the first inner wall side is faster than the flow speed of liquid flowing through a region close to the second inner wall. In Japanese Patent Application Laid-Open No. 2003-312006, the first inner wall is a surface perpendicular to the first and second openings, and therefore, the difference between the flow speeds is more remarkable. Thus, even if the second inner wall is an incline and has a shape that makes air bubbles likely to be stagnant, liquid is more likely to flow through the first inner wall side than through the second inner wall side. This results in preventing air bubbles from being stagnant on the second wall surface side.

The positions of the first and second openings, however, are determined based on the discharge element substrate and flow path members. Thus, there is a case where it is difficult to set the first inner wall as a surface perpendicular to the first and second openings. In such a case, a difference is less likely to occur between the flow speed of liquid flowing through a region close to the first inner wall and the flow speed of liquid flowing through a region close to the second inner wall. Thus, air bubbles may be stagnant near the second inner wall where the flow speed is slow. Further, if air bubbles are stagnant in a region close to the discharge element substrate in the distribution flow path, the air bubbles in the distribution flow path are likely to be mixed into pressure chambers of the discharge element substrate, and a discharge failure where liquid is not normally discharged from discharge ports may occur.

### SUMMARY OF THE DISCLOSURE

The present disclosure is directed to providing a liquid discharge head that includes a distribution flow path preventing air bubbles from being pulled into pressure chambers and prevents the occurrence of a discharge failure.

According to an aspect of the present disclosure, a liquid discharge head includes a discharge element substrate including a plurality of discharge port arrays in which a plurality of discharge ports configured to discharge liquid is arranged, a discharge element configured to generate a pressure for discharging liquid from the discharge ports, and a plurality of pressure chambers where a pressure generated by driving the discharge element acts on liquid, and a supporting member in which distribution flow paths, each configured to distribute liquid to the plurality of pressure chambers corresponding to the plurality of discharge port arrays, is formed, the supporting member supporting the discharge element substrate. The distribution flow path includes a first opening located on the discharge element substrate side, and a second opening located on the opposite side of the first opening. In a predetermined direction, an opening width of the first opening is larger than an opening width of the second opening, and a center of the opening width of the second opening is biased to one side with respect to a center of the opening width of the first opening. At least one bend portion is formed on an inner wall of the distribution flow path located on the one side. In a use state of the liquid discharge head, a bend portion closest to the first opening among the at least one bend portion is located on the second opening side of a center portion of the distribution flow path in a vertical direction.

Further features of the present disclosure will become apparent from the following description of exemplary embodiments with reference to the attached drawings.

### BRIEF DESCRIPTION OF THE DRAWINGS

FIG. 1 is a schematic perspective view of a liquid discharge apparatus to which liquid discharge heads are applicable.

FIG. 2 is a perspective view of a liquid discharge head.

FIG. 3 is an exploded perspective view of the liquid discharge head.

FIG. 4 is a schematic diagram illustrating a circulation path corresponding to a single color of ink in a steady state.

FIG. 5A is a cross-sectional view of a discharge element substrate at a position where a common supply flow path communicates with a connection surface. FIG. 5B is a cross-sectional view of the discharge element substrate at a position where neither the common supply flow path nor a common collection flow path communicates with the connection surface. FIG. 5C is a cross-sectional view of common collection flow path openings at a position where the common collection flow path communicates with the connection surface.

FIG. 6 illustrates a flow of ink in a case where recording is performed using most discharge ports.

FIG. 7 is a side view illustrating the liquid discharge head.

FIG. 8A is a cross-sectional view along VIIIa-VIIIa in FIG. 7. FIG. 8B is a cross-sectional view along VIIIb-VIIIb in FIG. 7.

FIG. 9 is a schematic diagram illustrating an inside of a circulation unit.

FIG. 10A a cross-sectional view illustrating a first air bubble storage flow path connected to a pressure control chamber. FIG. 10B is a cross-sectional view illustrating a second air bubble storage flow path connected to a pressure control chamber. FIG. 10C is a perspective view illustrating flow paths in a connection portion of a head housing unit and a supporting member.

FIG. 11A is a cross-sectional view illustrating a connection between the first air bubble storage flow path and a distribution flow path. FIG. 11B is a cross-sectional view illustrating a connection between the second air bubble storage flow path and an aggregation flow path.

FIG. 12A is a cross-sectional view illustrating the first air bubble storage flow path in a case where a large amount of air bubbles is accumulated. FIG. 12B is a cross-sectional view illustrating the second air bubble storage flow path in a case where a large amount of air bubbles is accumulated.

FIG. 13 is a diagram illustrating a cross section along XIII-XIII in FIG. 7.

FIG. 14 is a cross-sectional view of the distribution flow path.

FIG. 15 is a cross-sectional view of a distribution flow path in a conventional example.

FIG. 16 is a cross-sectional view of a second distribution flow path.

FIG. 17 is a cross-sectional view of the aggregation flow path.

FIG. 18 is a cross-sectional view of a second aggregation flow path.

FIG. 19A is a cross-sectional view of a pressure adjustment method in a state where a pressure plate and a flexible member are biased in a direction in which an inner volume of a first pressure control chamber increases. FIG. 19B is a cross-sectional view of the pressure adjustment method in an open state of a communication hole. FIG. 19C is a cross-sectional view of the pressure adjustment method in a closed state of the communication hole.

FIG. 20A is an external perspective view illustrating a front surface side of a circulation pump. FIG. 20B is an external perspective view illustrating a back surface side of the circulation pump.

FIG. 21 is a cross-sectional view of the circulation pump along XVII-XVII.

FIG. 22A is a schematic diagram illustrating a flow of ink in a state where a recording operation is performed. FIG. 22B is a schematic diagram illustrating a flow of ink in a state where the recording operation ends. FIG. 22C is a schematic diagram illustrating a flow of ink in a state where the communication hole is in the closed state.

FIG. 22D is a schematic diagram illustrating a flow of ink in a state where an inner volume of a second pressure control chamber increases. FIG. 22E is a schematic diagram illustrating a flow of ink in a state where the circulation pump is driven and the inner volume of the first pressure control chamber increases.

FIG. 23A is an exploded perspective view of a discharge unit when viewed from a first supporting member side. FIG. 23B is an exploded perspective view of the discharge unit when viewed from a discharge module side.

FIG. 24 is a diagram illustrating an opening plate.

FIG. 25 is a diagram illustrating a discharge element substrate.

FIG. 26A is a cross-sectional view along XXIIIa-XXIIIa illustrated in FIG. 23A.

FIG. 26B is a cross-sectional view along XXIIIb-XXIIIb illustrated in FIG. 23A. FIG. 26C is a cross-sectional view along XXIIIc-XXIIIc illustrated in FIG. 23A.

FIGS. 27A and 27B are cross-sectional views illustrating a vicinity of a discharge port in a discharge module.

FIG. 28 is a diagram illustrating a discharge element substrate in a comparative example.

FIG. 29A is a cross-sectional view of a discharge element substrate corresponding to ink of three colors. FIG. 29B is a planar perspective view of the discharge element substrate corresponding to ink of three colors.

FIG. 30 is a diagram illustrating a connection state of an ink tank, an external pump, and the liquid discharge head.

### DESCRIPTION OF THE EMBODIMENTS

With reference to the drawings, exemplary embodiments of the present disclosure will be described below.

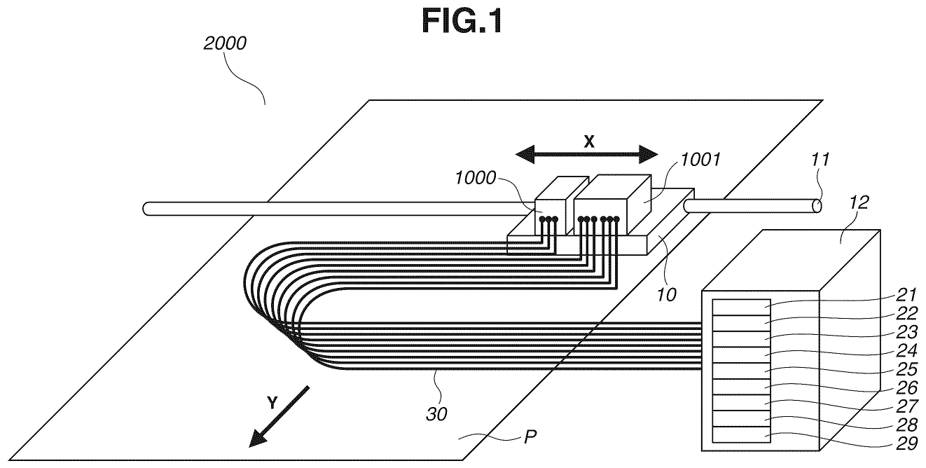

FIG. 1 is a schematic perspective view of a liquid discharge apparatus 2000 to which liquid discharge heads 1000 and 1001 according to the present exemplary embodiment are applicable. The liquid discharge apparatus 2000 according to the present exemplary embodiment is an inkjet recording apparatus using a serial scan method that records an image on a recording medium P by discharging liquid (hereinafter also referred to as “ink”) from the liquid discharge heads 1000 and 1001. The liquid discharge heads 1000 and 1001 can be mounted on a carriage 10. The carriage 10 moves along a guide shaft 11 in a main scanning direction that is an X-direction. The recording medium P is conveyed by a conveyance roller (not illustrated) in a sub-scanning direction that is a Y-direction intersecting (orthogonal to, in the present exemplary embodiment) the main scanning direction.

On the carriage 10, two types of liquid discharge heads are mounted. The liquid discharge head 1000 can discharge three types of ink, and the liquid discharge head 1001 can discharge six types of ink. To the liquid discharge heads 1000 and 1001, nine types of ink tanks 2 (21, 22, 23, 24, 25, 26, 27, 28, and 29) each supply ink in a pressurized manner through an ink supply tube 30. On an ink supply unit 12, a supply pump for supplying ink in a pressurized manner is mounted.

As a variation, it is also possible to reduce the ink tanks 2 to seven types by setting the three types of ink for the liquid discharge head 1000 to the similar type of ink, or form a liquid discharge apparatus capable of discharging twelve or more types of ink by adding liquid discharge heads to be mounted.

Since the liquid discharge heads 1000 and 1001 have similar configurations, the following description is given based on the liquid discharge head 1000.

The liquid discharge head 1000 is fixedly supported by the carriage 10, using a positioning method and an electrical contact of the carriage 10, and performs recording by discharging ink while being moved in the scanning direction that is the X-direction.

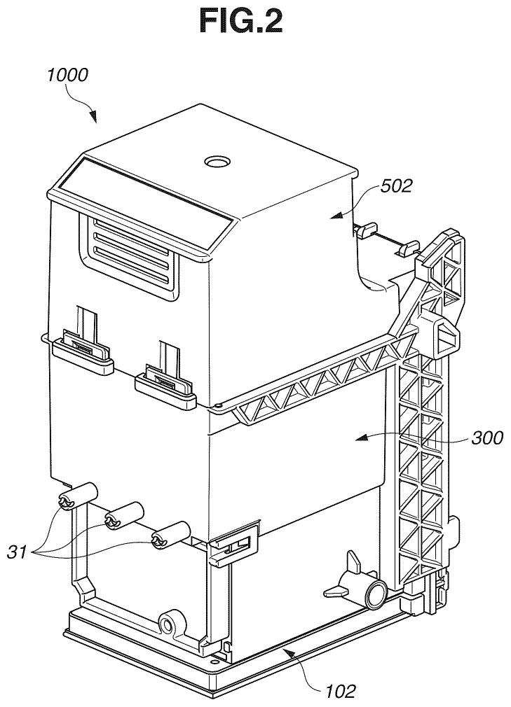

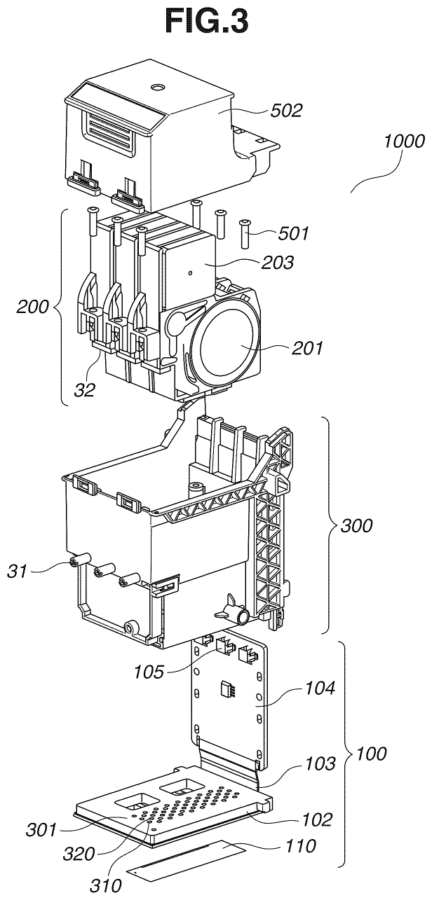

FIG. 2 is a perspective view of the liquid discharge head 1000 according to the present exemplary embodiment. FIG. 3 is an exploded perspective view of the liquid discharge head 1000. The liquid discharge head 1000 includes a recording element unit 100, a circulation unit 200, a head housing unit 300, and a cover 502. The recording element unit 100 includes a discharge element substrate 110, a supporting member 102 including distribution flow paths 310 and aggregation flow paths 320, an electrical wiring tape 103, and an electrical contact substrate 104. The electrical contact substrate 104 includes an electrical contact with the carriage 10 and supplies driving signals and energy to circulation pumps 203 mounted on the circulation unit 200 via circulation unit connectors 105 and pump wiring (not illustrated). The electrical contact substrate 104 also supplies driving signals and energy for discharging ink to the discharge element substrate 110 via the electrical wiring tape 103.

Although an electric connection portion is achieved by an anisotropic conductive film (not illustrated), wire bonding, or solder mounting, the connection method is not limited to this. In the present exemplary embodiment, the discharge element substrate 110 and the electrical wiring tape 103 are connected together by wire bonding, and this electric connection portion is sealed by a sealing material and protected from corrosion due to ink or an external impact.

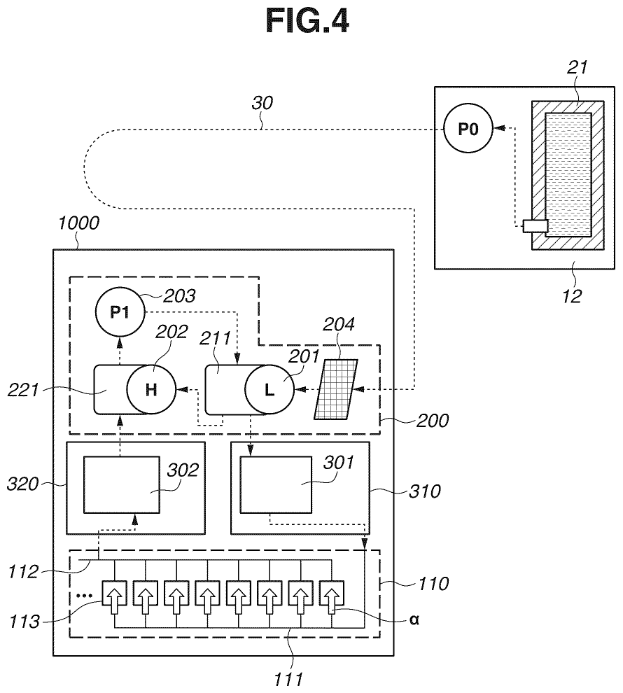

The circulation unit 200 includes first pressure control mechanisms 201, second pressure control mechanisms 202 (see FIG. 4), and the circulation pumps 203. To ink supply ports 32, ink tanks 2 supply ink from ink supply tubes 30 (see FIG. 1) through the head housing unit 300 including tube connection portions 31. In the present exemplary embodiment, the circulation unit 200 is fixed to the head housing unit 300 with screws 501, thereby forming ink supply paths. As a sealing member used in a connection portion in each ink supply path, an elastic member such as rubber or an elastomer is employed. Although it is desirable that the liquid discharge head 1000 according to the present exemplary embodiment should include the circulation unit 200, the liquid discharge head 1000 may not include the circulation unit 200. That is, the circulation unit 200 may be provided outside the liquid discharge head 1000.

The recording element unit 100 is bonded and fixed to the head housing unit 300, thereby forming ink supply paths. In a connection portion in each ink supply path, an elastic body may be used. To position the head housing unit 300 relative to the carriage 10 or form an ink flow path shape, the head housing unit 300 is formed by combining a component obtained by injection-molding a filler-containing resin.

In the discharge element substrate 110, a discharge port array is formed in which a plurality of discharge ports for discharging liquid in the Y-direction is arranged. A plurality of discharge port arrays is provided in the X-direction. That is, each discharge port array extends along a direction approximately orthogonal to a predetermined direction (the X-direction).

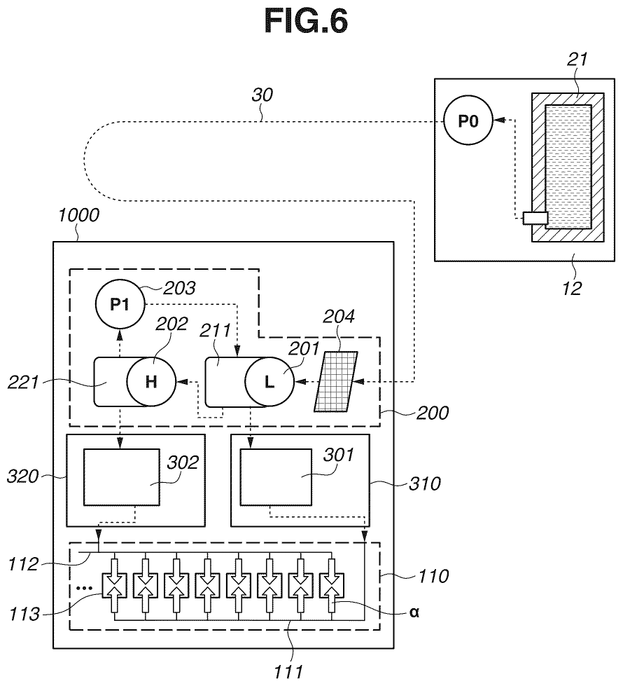

FIG. 4 is a schematic diagram illustrating a circulation path corresponding to a single color of ink in a steady state that is applied to the liquid discharge apparatus 2000 according to the present exemplary embodiment. The ink tank 21 supplies ink in a pressurized manner to the liquid discharge head 1000 through a supply pump P0. After dirt is removed from the ink by a filter 204, the ink is supplied to a first pressure control mechanism 201. In FIG. 4 (also FIG. 6), “L” is written in the first pressure control mechanism 201, and “H” is written in a second pressure control mechanism 202. “H” indicates a high negative pressure, and “L” indicates a low negative pressure. This is opposite to highness and lowness based on a positive pressure. The first pressure control mechanism 201 adjusts the pressure in a first pressure control chamber 211 to a predetermined pressure (a negative pressure). A circulation pump 203 is a piezoelectric diaphragm pump that changes the volume in a pump chamber by inputting a driving voltage to a piezoelectric element attached to a diaphragm and sends liquid by two check valves alternately moving by a change in the pressure.

The circulation pump 203 sends ink from a second pressure control chamber 221 on the low pressure (high negative pressure) side to the first pressure control chamber 211 on the high pressure (low negative pressure) side. The pressure in the second pressure control chamber 221 is adjusted to a lower pressure than that in the first pressure control chamber 211 by the second pressure control mechanism 202. In the discharge element substrate 110, a plurality of pressure chambers 113, each including a discharge port capable of discharging liquid, is placed. A common supply flow path 111 and a common collection flow path 112 are connected to all the pressure chambers 113.

Common supply flow path openings 121 are connected to the first pressure control chamber 211 via a distribution flow path 310 and a first air bubble storage flow path (air bubble storage portion) 301, and therefore, the pressure in the common supply flow path openings 121 is adjusted to the high pressure (upstream) side. Alternatively, the common supply flow path 111 may be connected to the first pressure control chamber 211 via a second distribution flow path 2310 instead of the distribution flow path 310. The common collection flow path 112 is connected to the second pressure control chamber 221 via an aggregation flow path 320 and a second air bubble storage flow path 302, and therefore, the pressure in the common collection flow path 112 is adjusted to the low pressure (downstream) side. Alternatively, the common collection flow path 112 may be connected to the second pressure control chamber 221 via a second aggregation flow path 2320 instead of the aggregation flow path 320. Due to the pressure difference between the common supply flow path 111 and the common collection flow path 112, a flow in the direction of an arrow a in FIG. 4 occurs in each pressure chamber 113. By this flow of ink due to the pressure difference, ink that is not discharged during waiting or recording and locally thickens near discharge ports is collected from the pressure chambers 113. Thus, it is possible to prevent a discharge failure.

In the present exemplary embodiment, each of the first air bubble storage flow path 301 and the second air bubble storage flow path 302 has a volume capable of storing air bubbles generated in an ink path during recording or waiting.

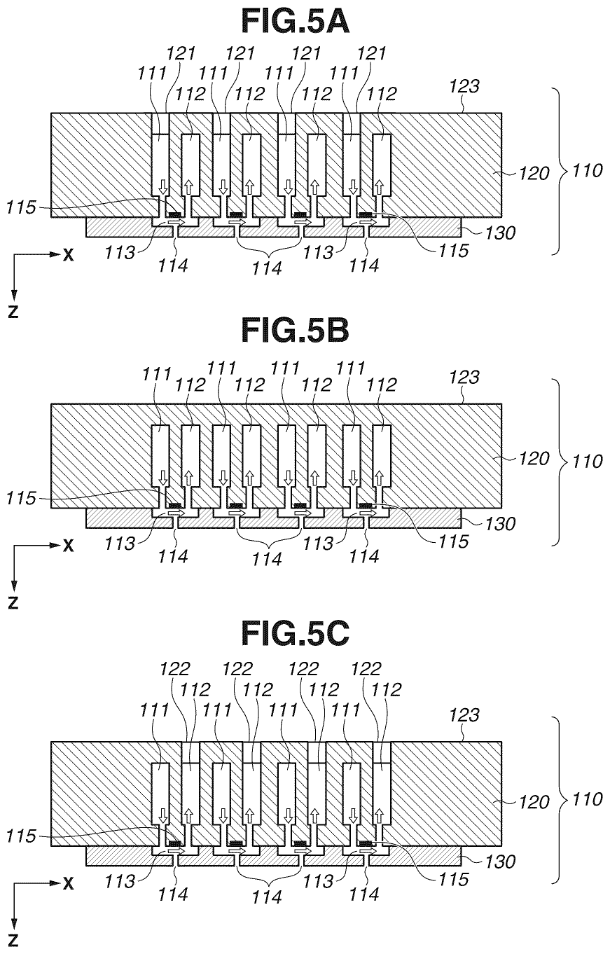

FIGS. 5A to 5C are cross-sectional views of the discharge element substrate 110 at different positions in the Y-direction. The discharge element substrate 110 includes a silicon (Si) substrate 120 in which an electric circuit (not illustrated) and heaters 115 that are discharge elements for generating pressures for discharging liquid from discharge ports are placed, and the pressure chambers 113 on which pressure generated by driving the discharge elements (the heaters 115) acts. Further, the discharge element substrate 110 includes a discharge port member 130 in which discharge ports 114 are patterned by photolithography. In the present exemplary embodiment, discharge energy is obtained by applying voltages to the heaters 115 and foaming ink in the pressure chambers 113. The discharge elements as pressure generation mechanisms, however, are not limited to these. A piezoelectric element may be used instead of each heater 115. The Si substrate 120 includes a connection surface 123. The connection surface 123 is bonded and fixed to the supporting member 102, and the discharge element substrate 110 is connected to ink supply paths.

In the present exemplary embodiment, to ensure the property of supplying ink to the pressure chambers 113 and reduce costs by downsizing the substrate, the common supply flow path 111 and the common collection flow path 112 are formed such that the distance in the X-direction between the common supply flow path 111 and the common collection flow path 112 is at a pitch of 1 mm or less. In terms of discharge efficiency in the recording medium P, four discharge port arrays in which discharge ports 114 are arranged at 600 dpi are placed. The placement resolution of discharge ports 114 and the number of discharge port arrays are not limited to these.

FIG. 5A illustrates cross sections of common supply flow path openings 121 at a position where the common supply flow path 111 communicates with the connection surface 123. FIG. 5B illustrates a cross section at a position where neither the common supply flow path 111 nor the common collection flow path 112 communicates with the connection surface 123. FIG. 5C illustrates cross sections of common collection flow path openings 122 at a position where the common collection flow path 112 communicates with the connection surface 123.

To control the pressure difference between the common supply flow path 111 and the common collection flow path 112, it is necessary to divide ink supply paths in addition to the pressure chambers 113 and the pressure control mechanism portions. At the position of the cross section illustrated in FIG. 5B, the distribution flow paths 310 and the aggregation flow paths 320 are divided in the discharge port array direction. The cross-sectional areas of the common supply flow path 111 and the common collection flow path 112 are very small, and the supply of ink may be insufficient due to pressure loss by the sending of liquid. Thus, it is desirable to make the portions of the common supply flow path 111 and the common collection flow path 112 that do not communicate with the connection surface 123 illustrated in FIG. 5B as short as possible. Thus, it is desirable that many of the common supply flow path openings 121 illustrated in FIG. 5A and many of the common collection flow path openings 122 illustrated in FIG. 5C should be provided in the discharge port array direction.

In the exploded perspective view in FIG. 3, nine distribution flow paths 310 are placed per color, and eight aggregation flow paths 320 are placed per color. The number of places where the distribution flow paths 310 and the aggregation flow paths 320 are connected together differs depending on the length and the joining width of each discharge port array. In the present exemplary embodiment, each of the cross-sectional areas of the common supply flow path 111 and the common collection flow path 112 in FIG. 5B is 0.1 mm² or less. The distance between a common supply flow path opening 121 and a common collection flow path opening 122 is 7.5 mm or less.

FIG. 6 illustrates the flow of ink in the circulation path corresponding to a single color in a case where recording is performed using most of the discharge ports in the present exemplary embodiment. In a case where recording is performed using most of the discharge ports, the manner of the flow differs from the circulation in the steady state, and ink is supplied from both the common supply flow path 111 and the common collection flow path 112 to the pressure chambers 113.

If ink in the pressure chambers 113 is discharged, ink is supplied from each of the common supply flow path 111 and the common collection flow path 112. The common supply flow path 111 supplies ink supplied from the first pressure control chamber 211 through the distribution flow path 310 and the first air bubble storage flow path 301 to the pressure chambers 113. In a case where a large amount of liquid is discharged, the common collection flow path 112 supplies ink supplied from the second pressure control chamber 221 through the aggregation flow path 320 and the second air bubble storage flow path 302 to the pressure chambers 113. Similarly to the steady state, the circulation pump 203 transports ink from the second pressure control chamber 221 to the first pressure control chamber 211.

At this time, the second pressure control chamber 221 supplies ink to the aggregation flow path 320 and the circulation pump 203. Further, the pressure in the second pressure control chamber 221 is maintained constant by the second pressure control mechanism 202 supplying ink from the first pressure control chamber 211 through a bypass flow path connecting the first pressure control mechanism 201 and the second pressure control mechanism 202. Although the first pressure control chamber 211 supplies ink to the second pressure control mechanism 202 and the distribution flow path 310, the pressure in the first pressure control chamber 211 is maintained constant by the first pressure control mechanism 201 collecting ink from the ink tank 21 as an ink supply source in addition to ink transported from the circulation pump 203.

As described above, the flow direction of ink in the common collection flow path 112 changes according to the recording state, and accordingly, the flow direction of ink in the aggregation flow path 320 and the second air bubble storage flow path 302 changes.

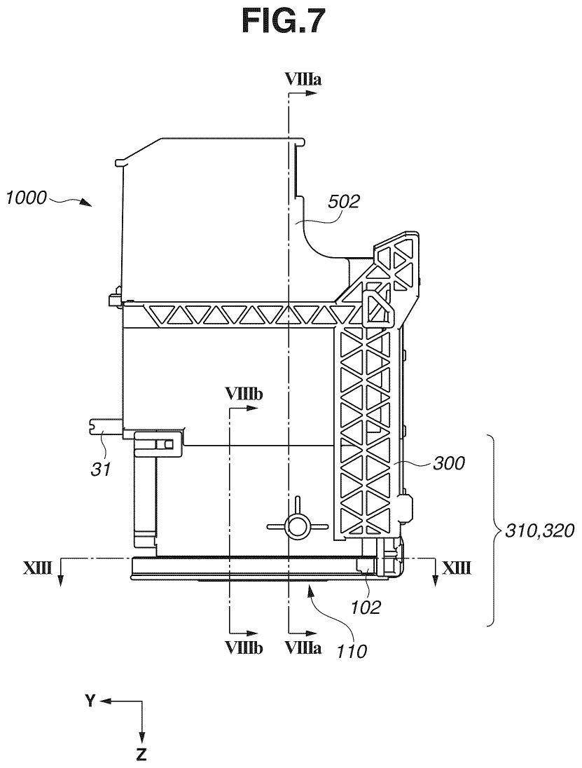

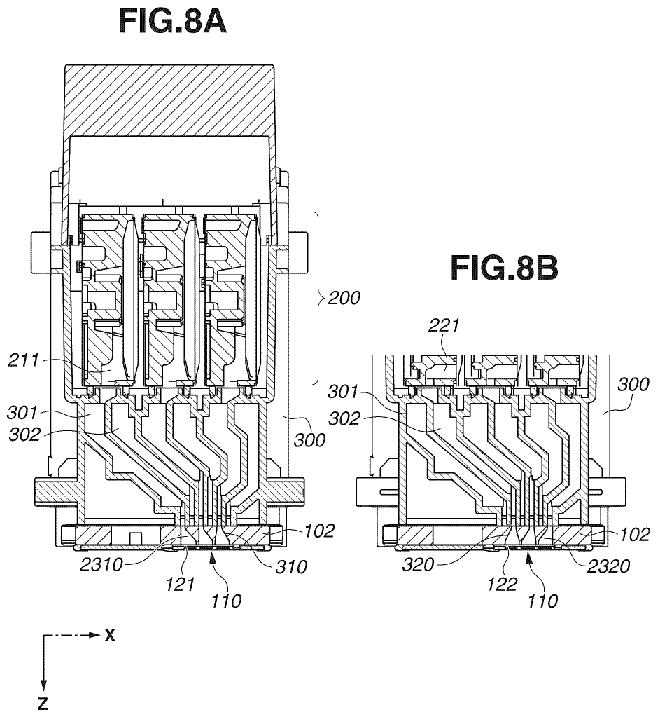

FIG. 7 is a side view illustrating the liquid discharge head 1000. FIG. 8A is a cross-sectional view along VIIIa-VIIIa in FIG. 7. FIG. 8B is a cross-sectional view along VIIIb-VIIIb in FIG. 7. In the discharge element substrate 110, the discharge port arrays are provided along the Y-direction, which is the moving direction of the recording medium P. The discharge ports discharge ink in a Z-direction. The distribution flow path 310 and the aggregation flow path 320 are formed by the head housing unit 300 and the supporting member 102.

The discharge element substrate 110 is supported by the supporting member 102 so that the first pressure control chamber 211 is connected to the common supply flow path openings 121 and the common supply flow path 111 via the first air bubble storage flow path 301 and the distribution flow path 310. As illustrated in FIG. 8B, the discharge element substrate 110 is also supported so that the second pressure control chamber 221 is connected to the common collection flow path openings 122 and the common collection flow path 112 via the second air bubble storage flow path 302 and the aggregation flow path 320.

The first pressure control chamber 211 and the second pressure control chamber 221 are controlled to have constant pressure forces by the pressure control mechanisms 201 and 202 formed in the circulation unit 200.

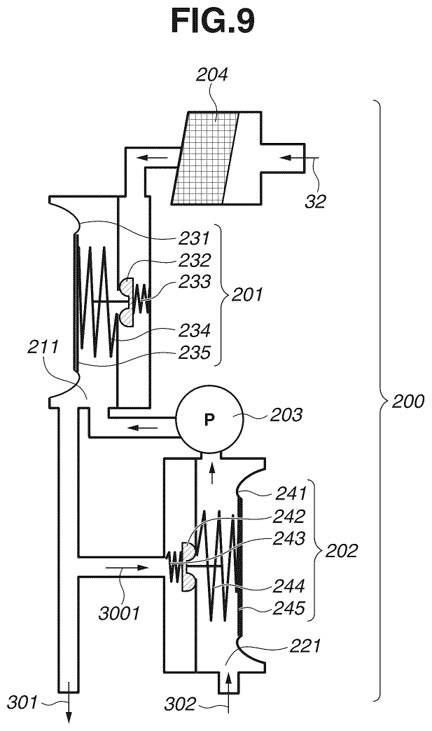

FIG. 9 is a schematic diagram illustrating the inside of the circulation unit 200. The circulation unit 200 supplies ink in a pressurized manner from the ink supply unit 12 to the first pressure control mechanism 201 through an ink supply port 32 and the filter 204. The first pressure control mechanism 201 includes a valve 232, a valve spring 233, a flexible member 231, a pressure plate 235, and a pressure adjustment spring 234.

In the first pressure control chamber 211, if the volume of the first pressure control chamber 211 decreases due to the ejection of ink, the pressure plate 235 deforms the flexible member 231 and the pressure adjustment spring 234, thereby attempting to maintain the pressure in the first pressure control chamber 211 constant. The pressure adjustment spring 234 compressively deforms, thereby deforming the valve spring 233 in a compression direction through the valve 232. This can open the valve 232 and supply ink to the first pressure control chamber 211. By this behavior, it is possible to supply ink and maintain the pressure in the first pressure control chamber 211 constant. The negative pressure in the first pressure control chamber 211 is set based on the positions where the pressure adjustment spring 234 and the valve 232 are in contact with the pressure plate 235.

The second pressure control mechanism 202 of the second pressure control chamber 221 includes a valve 242, a valve spring 243, a flexible member 241, a pressure plate 245, and a pressure adjustment spring 244. The adjustment principle of the pressure in the second pressure control mechanism 202 is similar to the principle of the first pressure control mechanism 201 except that the ink supply source changes from the ink supply unit 12 to the first pressure control chamber 211.

The circulation pump 203 is connected to the second pressure control chamber 221 and the first pressure control chamber 211 so that the circulation pump 203 sends ink in the second pressure control chamber 221 to the first pressure control chamber 211. In the present exemplary embodiment, as the circulation pump 203, a small diaphragm pump using a piezoelectric element is employed. The pump 203 can be driven by applying a voltage pulse to the piezoelectric element. Thus, it is possible to control the on/off states of the circulation pump 203 by an input voltage pulse. The circulation pump 203 transfers ink in the second pressure control chamber 221 to the first pressure control chamber 211, whereby the first pressure control chamber 211 is pressurized by an amount corresponding to the sending of the liquid, and the pressure control chamber 221 changes to a negative pressure by an amount corresponding to the sending of the liquid.

The second pressure control chamber 221 collects ink through the second pressure control mechanism 202 by an amount corresponding to the change to the negative pressure. However, since the second pressure control mechanism 202 collects ink from the first pressure control chamber 211 and the pressure chambers 113, a circulation flow occurs while the pressure in the second pressure control chamber 221 is maintained constant. The circulation flow through the pressure chambers 113 thus occurs, whereby it is possible to remove ink thickening by the evaporation of ink near discharge ports. Thus, it is possible to stably discharge ink.

In a case where a large amount of liquid is discharged, the supply of liquid does not catch up with the discharge by merely supplying liquid from the first pressure control chamber 211 to the pressure chambers 113, and it is necessary to also supply liquid from the second pressure control chamber 221 to the pressure chambers 113. If liquid is supplied from the second pressure control chamber 221 to the pressure chambers 113, the inside of the second pressure control chamber 221 changes to a negative pressure by an amount corresponding to the supplied liquid. Thus, the pressure adjustment spring 244 contracts, and the valve 242 is released. Then, liquid flows into the second pressure control chamber 221 from a bypass flow path 3001 to cancel the negative pressure in the second pressure control chamber 221. That is, in a case where a large amount of liquid is discharged, liquid is supplied to the second pressure control chamber 221 not through the pressure chambers 113, and liquid is supplied to the pressure chambers 113 not only from the common supply flow path 111 but also from the common collection flow path 112.

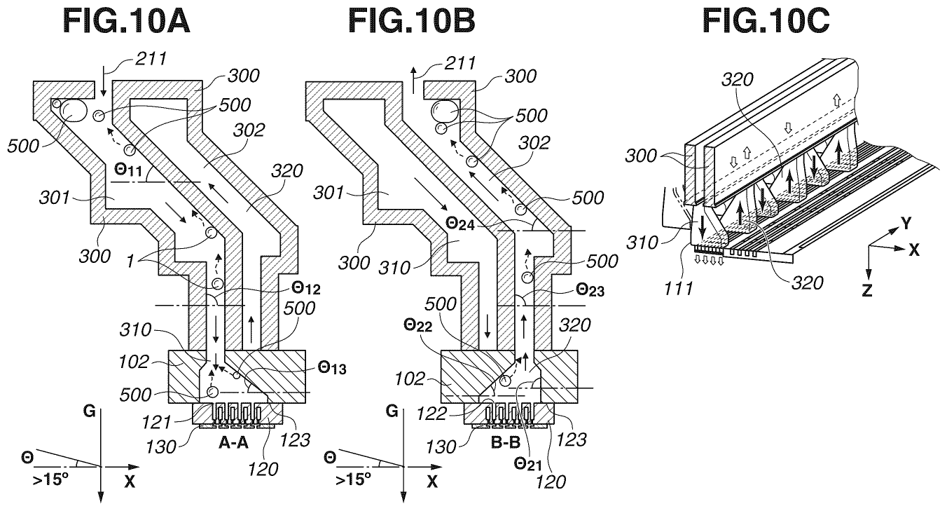

FIG. 10A is a cross-sectional view illustrating the first air bubble storage flow path 301 connected to the first pressure control chamber 211 according to the present exemplary embodiment. FIG. 10B is a cross-sectional view illustrating the second air bubble storage flow path 302 connected to the second pressure control chamber 221. FIG. 10C is a perspective view illustrating flow paths in a connection portion of the head housing unit 300 and the supporting member 102. The supporting member 102 supports the discharge element substrate 110, thereby forming the distribution flow path 310 and the aggregation flow path 320. The distribution flow path 310 is a flow path that distributes liquid supplied from the first pressure control chamber 211 to the plurality of pressure chambers 113. The aggregation flow path 320 is a flow path that aggregates liquid from the plurality of pressure chambers 113 through a collection flow path. The distribution flow path 310 and the aggregation flow path 320 will be described below. Further, the discharge element substrate 110 includes the Si substrate 120 and the discharge port member 130. On the Si substrate 120, a heat retention heater (not illustrated) for stabilizing discharge is placed. To equalize the temperature of the entirety of the discharge element substrate 110 and ensure the stability of joining the supporting member 102 to the Si substrate 120, an alumina material of which the linear expansion is close to that of Si and which has high thermal conductivity is employed in the supporting member 102.

In FIGS. 10A and 10B, an arrow (a solid line) illustrated in a flow path indicates the flow of liquid by driving the circulation pump 203 when recording is not performed. Specifically, in FIG. 10A, liquid flows from the first pressure control chamber 211 to the common supply flow path openings 121 through the head housing unit 300 forming the first air bubble storage flow path 301 and the distribution flow path 310. Further, the liquid flows from the common supply flow path 111, passes through the pressure chambers 113 from which ink is discharged, flows to the common collection flow path 112, and is collected in the common collection flow path openings 122. Then, the liquid collected in the common collection flow path openings 122 passes through the aggregation flow path 320 formed by the supporting member 102 and the second air bubble storage flow path 302 and is collected in the second pressure control chamber 221. Further, the circulation pump 203 sends the liquid from the second pressure control chamber 221 to the first pressure control chamber 211, whereby a circulation flow is formed.

The circulation flow is completed in ink flow paths of the liquid discharge head 1000, and therefore, air bubbles 500 generated in the flow paths of the liquid discharge head 1000 are present in any parts of the circulation flow. The air bubbles 500 are generated by bubbling when ink is replenished or due to the flow of ink, or by the supersaturation of gas dissolved in ink due to a temperature rise or a reduction in the pressure in the liquid discharge head 1000. If the air bubbles 500 flow into the pressure chambers 113, the air bubbles 500 may cause a discharge failure of ink and lead to a printing failure. Thus, it is necessary to pull the air bubbles 500 away from the pressure chambers 113 so that the air bubbles 500 do not flow into the pressure chambers 113.

In a case where a general liquid discharge head does not include a flow path that accumulates air bubbles, it is necessary to control the degree of deaeration of ink to be used and use the ink in a range where dissolved gas is not supersaturated, or eject generated air bubbles to outside the head each time. Examples of the method for controlling the degree of deaeration include depressurization agitation and a deaeration module using a hollow fiber membrane. These methods, however, may lead to high costs and increases in the size and the weight of the head and influence the printing speed. If ink including air bubbles is ejected each time, ink is used for wasting without recording. This may influence printing costs.

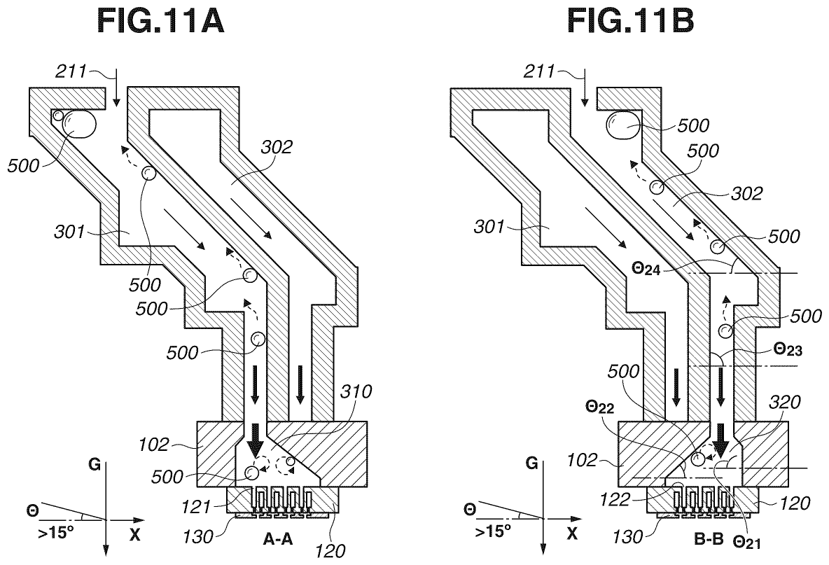

FIGS. 11A and 11B are diagrams illustrating the flow of ink and the behavior of the air bubbles 500 in the case where recording is performed using most of the discharge ports that is illustrated in FIG. 6. FIG. 11A is a cross-sectional view illustrating the connection between the first air bubble storage flow path 301 and the distribution flow path 310. FIG. 11B is a cross-sectional view illustrating the connection between the second air bubble storage flow path 302 and the aggregation flow path 320. The position of the cross section in FIG. 11A is similar to the position of the cross section in FIG. 10A. The position of the cross section in FIG. 11B is similar to the position of the cross section in FIG. 10B. In a case where recording is performed using most of the discharge ports, i.e., in a case where a large amount of liquid is discharged, more ink is supplied to the pressure chambers 113 than that of the circulation flow in the non-recording state illustrated in FIGS. 10A to 10C, and a large flow occurs in the flow paths. In the distribution flow path 310 and the aggregation flow path 320, the circulation flow of ink is a flow toward the pressure chambers 113. The flow rate of ink increases, whereby the flow speed of ink increases overall in a direction toward the pressure chambers 113.

Particularly, in the distribution flow path 310 and the aggregation flow path 320 formed by the supporting member 102 and having relatively small flow path cross-sectional areas, a fast flow speed occurs, and a dynamic pressure applied to the air bubbles 500 becomes great. This increases the possibility that the air bubbles 500 flow into the pressure chambers 113. In the present exemplary embodiment, since the discharge energy in the pressure chambers 113 is generated by the thermal energy of the heaters 115, the temperature of the discharge element substrate 110 rises according to the discharge of ink. Thus, the temperature in a circulation flow path formed by the supporting member 102 and the discharge element substrate 110 is relatively high, and gas dissolved in ink is supersaturated. This increases the possibility that the air bubbles 500 are generated.

As described above, in a case where recording is performed using most of the discharge ports, it is necessary to move the air bubbles 500 to the first air bubble storage flow path 301 or the second air bubble storage flow path 302 by periodically entering the circulation state when recording is not performed or stopping the circulation according to the discharge amount of ink or the discharge time of ink. This movement time of the air bubbles 500 may involve the stop of recording as described above, and this may decrease printing productivity. Thus, to shorten the movement time of the air bubbles 500, it is desirable to set a ceiling surface at an angle close to 90 degrees at which 100% of a force corresponding to the buoyancy of the air bubbles 500 can be used as a movement force.

There is also a case where an ink temperature adjustment heater is mounted on the discharge element substrate 110. It is also possible to employ a resin material having low thermal conductivity in the supporting member 102 with an emphasis on the temperature adjustment speed. In this case, places where the air bubbles 500 are generated due to heat are limited to near the Si substrate 120.

The common supply flow path 111 formed in the discharge element substrate 110 is formed by an Si substrate processing technique. Thus, it is difficult to sufficiently obtain an angle to a surface on which the discharge ports are placed, and the flow path cross-sectional area is very small. Thus, it is difficult to guide the air bubbles 500 to the first air bubble storage flow path 301 by the buoyancy against the circulation flow. Thus, it is necessary to periodically eject the air bubbles 500 generated inside the common supply flow path 111 by suction from the pressure chambers 113 through the discharge ports according to the discharge amount of ink or the recording time. However, since the volume of ink in the common supply flow path 111 is very small, it is possible to minimize waste ink.

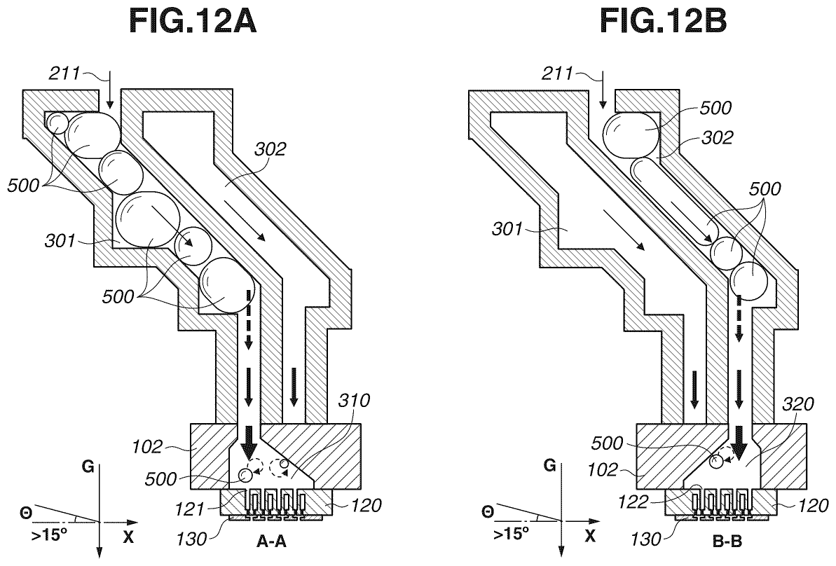

FIG. 12A is a cross-sectional view illustrating the first air bubble storage flow path 301 in a case where a large amount of the air bubbles 500 is accumulated. FIG. 12B is a cross-sectional view illustrating the second air bubble storage flow path 302 in a case where a large amount of the air bubbles 500 is accumulated. The positions of the cross sections in FIGS. 12A and 12B are similar to those in FIGS. 10A and 10B, respectively. If the air bubbles 500 are combined to a size that almost blocks each flow path cross-sectional area, the drag due to the flow of ink becomes great, and the air bubbles 500 are washed away to the pressure chambers 113.

However, each of the flow path cross-sectional areas of the first air bubble storage flow path 301 and the second air bubble storage flow path 302 including ceiling portions is larger than the minimum cross-sectional area portion in the air bubble storage flow path, and a plurality of slit portions (not illustrated) is provided along the flow direction of ink on walls of the flow path. The slit portions are formed to be sufficiently thin so that the slit portions are not blocked by the air bubbles 500. Thus, the relative flow speed of ink in each air bubble storage flow path becomes slow, and it is possible to cause ink to flow from the slit portions without moving the air bubbles 500. Consequently, it is possible to prevent the air bubbles 500 from flowing into the pressure chambers 113. In the present exemplary embodiment, each of the slit portions has a groove shape having a width of 0.5 mm and has a structure that makes the air bubbles 500 that are accumulated and combined less likely to block the slit portion.

Even if the slit portions are thus provided, a certain amount of the air bubbles 500 may be accumulated in the first air bubble storage flow path 301 or the second air bubble storage flow path 302. Then, if the air bubbles 500 reach a flow path of which the cross-sectional area is small and the flow speed increases, the air bubbles 500 may flow into the pressure chambers 113 by the dynamic pressure of ink and cause a discharge failure. Thus, in a case where a certain amount of the air bubbles 500 is accumulated, it is necessary to perform a recovery operation by suction from the discharge ports to eject the air bubbles 500 to outside. As a suction recovery device that performs the recovery operation by suction, a conventional device can be employed.

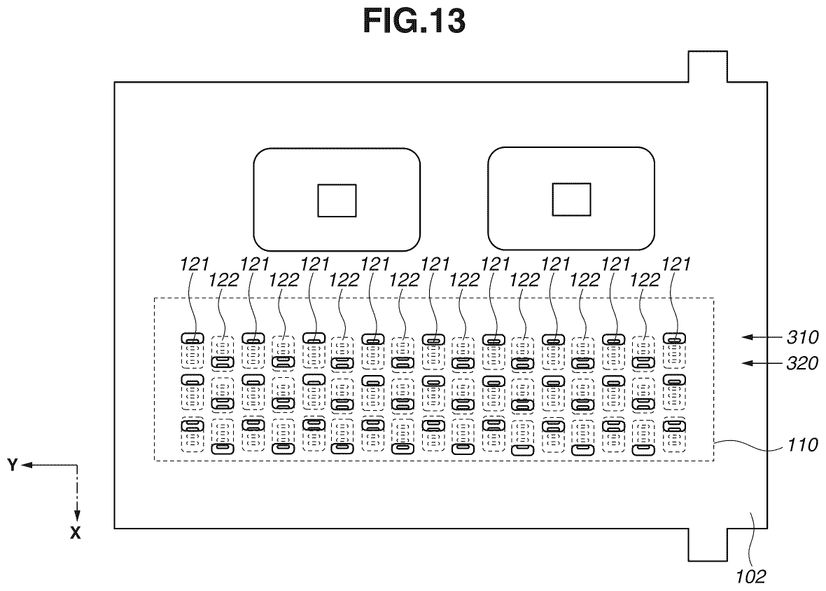

FIG. 13 is a diagram illustrating a cross section along XIII-XIII in FIG. 7. The flow path cross-sectional areas of the first air bubble storage flow path 301 and the second air bubble storage flow path 302 are made as wide as possible, whereby it is possible to move the generated air bubbles 500 to the ceiling portions. Thus, it is desirable to form the first air bubble storage flow path 301 and the second air bubble storage flow path 302 of which the flow path cross-sectional areas are great up to near the discharge element substrate 110 where the air bubbles 500 are likely to be generated.

In a case where nine common supply flow path openings 121 and eight common collection flow path openings 122 are alternately placed in the discharge port array direction as in the present exemplary embodiment, openings 121 and 122 are connected together by a flow path of which the length of the long side in the Y-direction is longer than or equal to the lengths of both end portions of each discharge port array. In this case, it is necessary to place the distribution flow path 310 that supplies liquid to the openings 121 arranged at narrow pitches. In the present exemplary embodiment, however, as illustrated in the cross-sectional view in FIG. 8A, the distribution flow path 310 has a triangular shape including an oblique side inclined in the X-direction, which is the scanning direction. On the collection flow path side, it is necessary to place the aggregation flow path 320 that aggregates liquid from the common collection flow path openings 122. Similarly, however, in the present exemplary embodiment, as illustrated in the cross-sectional view in FIG. 8B, the aggregation flow path 320 has a triangular shape including an oblique side inclined in the X-direction, which is the scanning direction. The oblique side of the triangular shape of the distribution flow path 310 connected to the common supply flow path openings 121 and the oblique side of the triangular shape of the aggregation flow path 320 connected to the common collection flow path openings 122 are placed in directions opposite to each other.

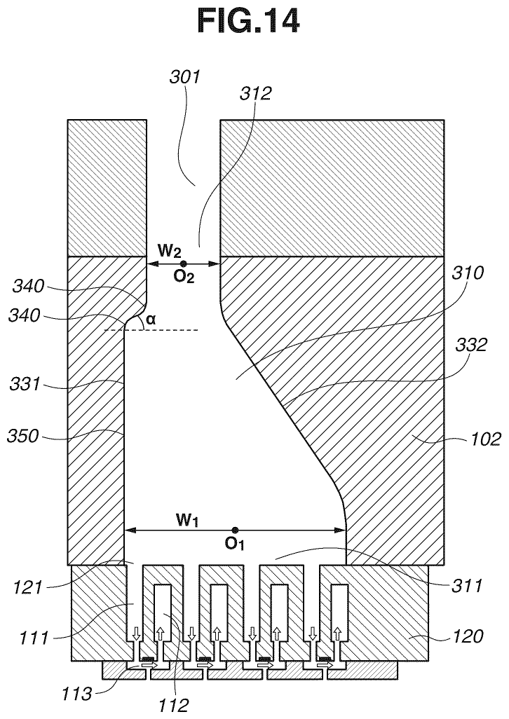

Next, a description is given of the detailed structure of the distribution flow path 310, which is a feature portion of the the present exemplary embodiment. FIG. 14 is an enlarged view of the distribution flow path 310 according to the present exemplary embodiment. The distribution flow path 310 is a flow path that distributes liquid to a plurality of pressure chambers 113 corresponding to a plurality of discharge port arrays. The distribution flow path 310 includes a first opening 311 located on the discharge element substrate 110 side. The first opening 311 is connected to the common supply flow path 111 via a plurality of common supply flow path openings 121. The distribution flow path 310 also includes a second opening 312 connected to the first air bubble storage flow path 301 (on the opposite side of the first opening 311). Then, the distribution flow path 310 is formed by inner walls connecting the first opening 311 and the second opening 312.

In the predetermined direction (the X-direction in FIG. 10C), an opening width W₁ of the first opening 311 is larger than an opening width W₂ of the second opening 312, and liquid is widely supplied through the distribution flow path 310. The structure of the distribution flow path 310 is determined based on the discharge element substrate 110 and flow path members (members forming the first air bubble storage flow path 301), and therefore, the positions of a center O₁ of the opening width W₁ of the first opening 311 and a center O₂ of the opening width W₂ of the second opening 312 are also determined based on the discharge element substrate 110 and the flow path members. In the distribution flow path 310 according to the present exemplary embodiment, in the predetermined direction (the X-direction in FIG. 10C), the center O₁ of the opening width W₁ of the first opening 311 and the center O2 of the opening width W₂ of the second opening 312 are formed in a shifted manner. In other words, in the predetermined direction, the center O₂ of the opening width W₂ of the second opening 312 is biased to one side (the left side on the plane of the paper in FIG. 14) with respect to the center O₁ of the opening width W₁ of the first opening 311. In such a case, a difference occurs in the flow speed of flowing liquid in the distribution flow path 310. An inner wall of the distribution flow path 310 on the one side (the left side on the plane of the paper in FIG. 14) is a first inner wall 331, and an inner wall opposed to the first inner wall 331 and located on the other side (the right side on the plane of the paper in FIG. 14) is a second inner wall 332. At this time, the first inner wall 331 extends so that the flow path width becomes larger from the second opening 312 to the first opening 311. Thus, the first inner wall 331 may include at least one bend portion 340. Near such a bend portion 340, the cross-sectional area of the flow path is great, and therefore, the flow speed of flowing liquid is small. That is, so-called “stagnation” occurs, and therefore, in a case where air bubbles are mixed into the distribution flow path 310, the air bubbles are likely to be stagnant in a region of stagnation.

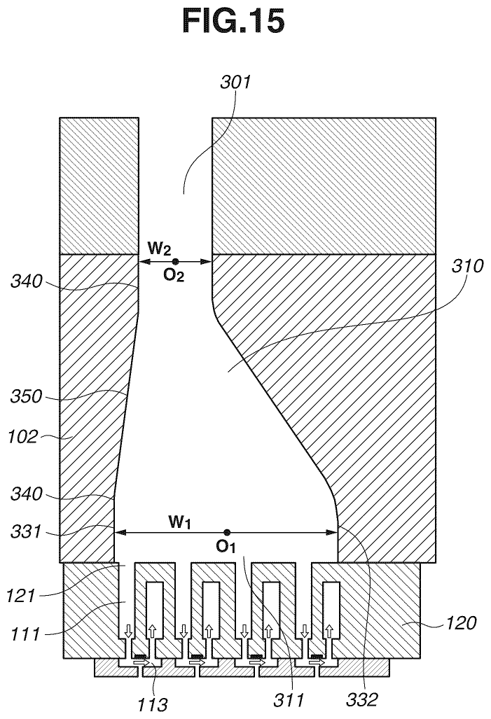

FIG. 15 illustrates the distribution flow path 310 in a conventional example. The distribution flow path 310 in the conventional example includes two bend portions 340 on the first inner wall 331. In the distribution flow path 310 in the conventional example, a region where stagnation occurs in the distribution flow path 310, i.e., the bend portion 340 closest to the first opening 311 among the bend portions 340, is located on the first opening 311 side of a center portion 350 of the distribution flow path 310 in the vertical direction. Thus, the distance between the bend portion 340 and the pressure chambers 113 is small, and air bubbles stagnant near the bend portion 340 are likely to be pulled into the pressure chambers 113. As described above, if air bubbles are mixed into the pressure chambers 113, a discharge failure may occur in liquid discharged from the discharge ports.

In contrast, in the distribution flow path 310 according to the present exemplary embodiment illustrated in FIG. 14, the bend portion 340 closest to the first opening 311 among the bend portions 340 formed on the first inner wall 331 is located on the second opening 312 side of the center portion 350 of the distribution flow path 310 in the vertical direction in the use state of the liquid discharge head 1000. Consequently, the distance between the bend portion 340 and the pressure chambers 113 is great, and air bubbles stagnant in the distribution flow path 310 including the bend portion 340 are less likely to be pulled into the pressure chambers 113. The use state of the liquid discharge head 1000 refers to the state where liquid is discharged from the liquid discharge head 1000, and an image or a character can be normally recorded on the recording medium P.

It is further desirable that the bend portion 340 closest to the first opening 311 among the bend portions 340 formed on the first inner wall 331 should be located on the second opening 312 side of a position at a third of the distribution flow path 310 on the upstream side in the vertical direction. With this form, it is possible to make the distance between the bend portion 340 and the pressure chambers 113 longer. Thus, it is possible to further prevent air bubbles from being pulled into the pressure chambers 113.

Alternatively, the bend portion 340 closest to the first opening 311 among bend portions 340 formed on the second inner wall 332 may be located on the first opening 311 side of the center portion 350 of the distribution flow path 310 in the vertical direction. This is because in the distribution flow path 310, the flow speed of liquid flowing through a region close to the first inner wall 331 is faster than the flow speed of liquid flowing through a region close to the second inner wall 332, and therefore, air bubbles are less likely to be stagnant near the bend portions 340 formed on the second inner wall 332. However, to further prevent air bubbles from being pulled into the pressure chambers 113, it is desirable to prevent also air bubbles slightly stagnant near the bend portions 340 formed on the second inner wall 332 from being pulled into the pressure chambers 113. That is, it is desirable that the bend portion 340 closest to the first opening 311 among the bend portions 340 formed on the second inner wall 332 should be located on the second opening 312 side of the center portion 350 of the distribution flow path 310 in the vertical direction.

It is also desirable that the distribution flow path 310 should include a first portion 341 and a second portion 342, and a bend portion 340 should be located between the first portion 341 and the second portion 342. It is further desirable that the distribution flow path 310 should include two bend portions 340 and include a third portion 343 connecting the first portion 341 and the second portion 342 via the two bend portions 340. With this configuration, it is possible to obtain the distribution flow path 310 according to the structures of the discharge element substrate 110 and the flow path members.

It is further desirable that as illustrated in FIG. 14, an angle α between a direction (the predetermined direction) perpendicular to the vertical direction and the third portion 343 should be 30° or more. If the inclination angle α of the third portion 343 is 30° or more, it is possible to prevent air bubbles from being stagnant near the third portion 343. Alternatively, the bend portions 340 may be formed at a right angle, the third portion 343 may not be an incline, and the inclination angle α may be 0°.

As illustrated in FIG. 10C, it is desirable that a plurality of distribution flow paths 310 having a similar shape should be formed in the discharge port array direction. Consequently, even if the liquid discharge head 1000 is long in the discharge port array direction, the common supply flow path 111 easily supplies liquid to the end portions of the discharge port array.

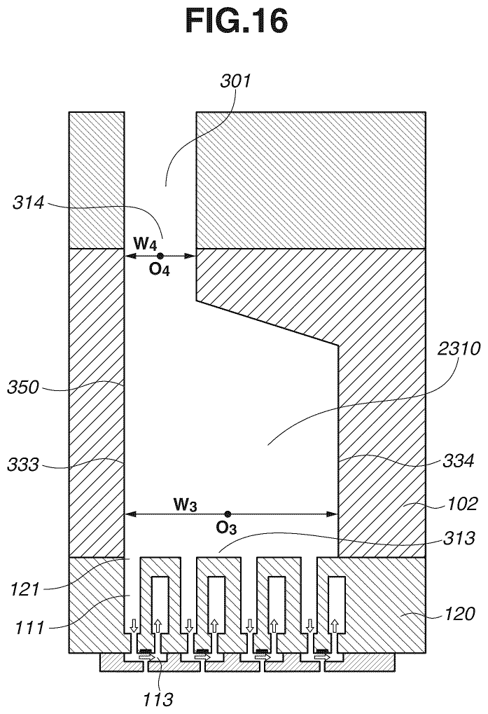

As illustrated in FIG. 8A, it is desirable that the supporting member 102 should also include a second distribution flow path 2310 arranged in parallel to the distribution flow path 310 in the predetermined direction (the X-direction). FIG. 16 illustrates the second distribution flow path 2310. The second distribution flow path 2310 is a flow path that distributes liquid to a plurality of pressure chambers 113 corresponding to discharge port arrays different from the distribution flow path 310. The second distribution flow path 2310 includes a third opening 313 located on the discharge element substrate 110 side, and a fourth opening 314 located on the opposite side of the third opening 313. In the predetermined direction (the X-direction), an opening width W₃ of the third opening 313 is larger than an opening width W₄ of the fourth opening 314, and an opening center O₃ of the third opening 313 and an opening center O₄ of the fourth opening 314 are shifted from each other. In other words, in the predetermined direction, the center O4 of the opening width W₄ of the fourth opening 314 is biased to one side (the left side on the plane of the paper in FIG. 16) with respect to the center O₃ of the opening width W₃ of the third opening 313. Unlike the distribution flow path 310, the second distribution flow path 2310 has a shape in which an inner wall (a third inner wall 333) of the second distribution flow path 2310 located on the one side (the left side on the plane of the paper in FIG. 16) does not include a bend portion 340. It is desirable that the second distribution flow path 2310 should have substantially the same shape as that of the distribution flow path 310 except that the third inner wall 333 does not include a bend portion 340. The distribution flow path 310 and the second distribution flow path 2310 serve to distribute liquid flowing from the first air bubble storage flow path 301 to a plurality of pressure chambers 113. Similarly to the distribution flow path 310, the shape of the second distribution flow path 2310 is also determined based on the flow path members and the discharge element substrate 110. The third inner wall 333 of the second distribution flow path 2310 does not include a bend portion 340, whereby it is possible to appropriately connect the flow path members and the discharge element substrate 110 without increasing the flow path width of the second distribution flow path 2310. A fourth inner wall 334 opposed to the third inner wall 333 in the predetermined direction (the X-direction) may include a bend portion 340.

Next, the aggregation flow path 320 is described. The aggregation flow path 320 is formed by the supporting member 102 and aggregates liquid from a plurality of pressure chambers 113 corresponding to a plurality of discharge port arrays through a plurality of collection flow paths. That is, the aggregation flow path 320 serves to aggregate liquid passing through the plurality of pressure chambers 113 and flowing through the collection flow paths of which the flow path widths are wide to the second air bubble storage flow path 302 of which the flow path width is narrow. As illustrated in FIG. 10C, it is desirable that distribution flow paths 310 and aggregation flow paths 320 should be alternately arranged in parallel along the Y-direction intersecting the predetermined direction (the X-direction). It is further desirable that the aggregation flow path 320 should have a shape obtained by flipping the distribution flow path 310 horizontally. With these features, it is possible to place the first air bubble storage flow path 301, the second air bubble storage flow path 302, the distribution flow path 310, and the aggregation flow path 320 in a limited space.

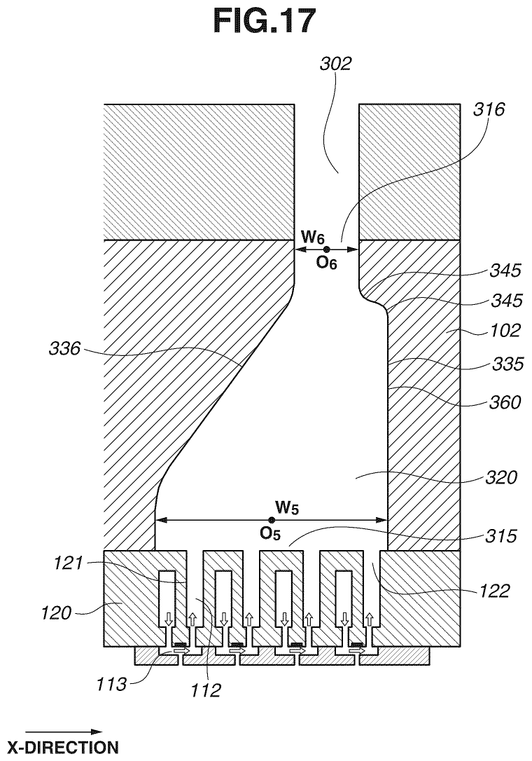

FIG. 17 illustrates an enlarged view of the aggregation flow path 320. The aggregation flow path 320 includes a fifth opening 315 located on the discharge element substrate 110 side. The fifth opening 315 is connected to the common collection flow path 112 via a plurality of common collection flow path openings 122. The aggregation flow path 320 also includes a sixth opening 316 connected to the second air bubble storage flow path 302 (on the opposite side of the fifth opening 315). Then, the aggregation flow path 320 is formed by inner walls connecting the fifth opening 315 and the sixth opening 316.

In the predetermined direction (the X-direction), an opening width W₅ of the fifth opening 315 is larger than an opening width W₆ of the sixth opening 316, and liquid flowing through the plurality of pressure chambers 113 is aggregated toward the second air bubble storage flow path 302 by the aggregation flow path 320. Similarly to the distribution flow path 310, the structure of the aggregation flow path 320 is determined based on the discharge element substrate 110 and flow path members, and therefore, the positions of an opening center O₅ of the fifth opening 315 and an opening center O6 of the sixth opening 316 are also determined based on the discharge element substrate 110 and the flow path members. In the aggregation flow path 320 according to the present exemplary embodiment, the opening center O₅ of the fifth opening 315 and the opening center O6 of the sixth opening 316 are shifted from each other in the predetermined direction (the X-direction). In other words, in the predetermined direction, the center O₆ of the opening width W₆ of the sixth opening 316 is biased to the other side (the right side on the plane of the paper in FIG. 17) on the opposite side of one side with respect to the center O₅ of the opening width W₅ of the fifth opening 315. In such a case, a difference occurs in the flow speed of flowing liquid in the aggregation flow path 320. An inner wall of the aggregation flow path 320 on the other side (the right side on the plane of the paper in FIG. 17) is a fifth inner wall 335, and an inner wall opposed to the fifth inner wall 335 is a sixth inner wall 336. At this time, the fifth inner wall 335 extends so that the flow path width becomes larger from the sixth opening 316 to the fifth opening 315. Thus, the fifth inner wall 335 includes at least one second bend portion 345.

It is desirable that in the aggregation flow path 320, the second bend portion 345 closest to the fifth opening 315 among the second bend portions 345 formed on the fifth inner wall 335 should be located on the sixth opening 316 side of a center portion 360 of the aggregation flow path 320 in the vertical direction. As described above, when a large amount of liquid is discharged, liquid is also supplied from the collection flow path side to the pressure chambers 113. At this time, if the second bend portion 345 is present at a position close to the pressure chambers 113, and when air bubbles flowing from the second air bubble storage flow path 302 are stagnant near the second bend portion 345, the air bubbles may be pulled into the pressure chambers 113. In the present exemplary embodiment, the second bend portion 345 closest to the fifth opening 315 is located on the sixth opening 316 side of the center portion 360, and therefore, it is possible to prevent air bubbles stagnant near the second bend portion 345 from being pulled into the pressure chambers 113.

As illustrated in FIG. 10C, it is desirable that a plurality of aggregation flow paths 320 should be formed in the discharge port array direction. It is also desirable that in each of the aggregation flow paths 320, the fifth opening 315 should be connected to a plurality of common collection flow path openings 122. Consequently, each aggregation flow path 320 easily aggregates liquid passing through the common collection flow path 112 corresponding to the plurality of discharge port arrays toward the second air bubble storage flow path 302.

As illustrated in FIG. 8A, it is desirable that the supporting member 102 should also include a second aggregation flow path 2320 arranged in parallel to the aggregation flow path 320 in the predetermined direction (the X-direction). The second aggregation flow path 2320 is a flow path that aggregates liquid from a plurality of pressure chambers 113 corresponding to discharge port arrays different from the aggregation flow path 320.

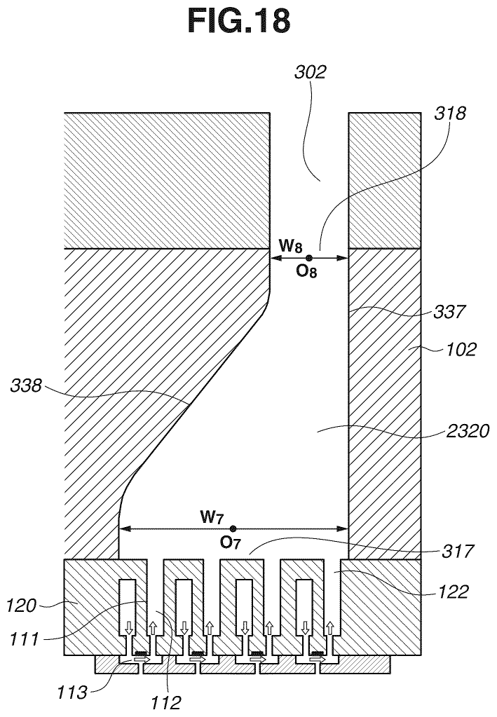

FIG. 18 illustrates an enlarged view of the second aggregation flow path 2320. The second aggregation flow path 2320 includes a seventh opening 317 located on the discharge element substrate 110 side, and an eighth opening 318 located on the opposite side of the seventh opening 317. The eighth opening 318 is connected to the second air bubble storage flow path 302. In the predetermined direction (the X-direction), an opening width W₇ of the seventh opening 317 is larger than an opening width W₈ of the eighth opening 318, and an opening center O₇ of the seventh opening 317 and an opening center O₈ of the eighth opening 318 are shifted from each other. In other words, in the predetermined direction (the X-direction), the center O₈ of the opening width W₈ of the eighth opening 318 is biased to the other side (the right side on the plane of the paper in FIG. 18) with respect to the center O₇ of the opening width W₇ of the seventh opening 317. Unlike the aggregation flow path 320, the second aggregation flow path 2320 has a shape in which an inner wall (a seventh inner wall 337) of the second aggregation flow path 2320 located on the other side (the right side on the plane of the paper in FIG. 18) does not include a second bend portion 345. It is desirable that the second aggregation flow path 2320 should have substantially the same shape as that of the aggregation flow path 320 except that the seventh inner wall 337 does not include a second bend portion 345. Similarly to the aggregation flow path 320, the shape of the second aggregation flow path 2320 is also determined based on flow path members and the discharge element substrate 110. The seventh inner wall 337 of the second aggregation flow path 2320 does not include a second bend portion 345, whereby it is possible to appropriately connect the flow path members and the discharge element substrate 110 without increasing the flow path width of the second aggregation flow path 2320. An eighth inner wall 338 opposed to the seventh inner wall 337 in the predetermined direction (the X-direction) may include a second bend portion 345.

It is desirable that second distribution flow paths 2310 and second aggregation flow paths 2320 should be alternately arranged in parallel along a direction intersecting the predetermined direction. It is further desirable that the second aggregation flow path 2320 should have a shape obtained by flipping the second distribution flow path 2310 horizontally. With these features, it is possible to place the first air bubble storage flow path 301, the second air bubble storage flow path 302, the second distribution flow path 2310, and the second aggregation flow path 2320 in a limited space.

As illustrated in FIG. 8A, in an array in which the distribution flow path 310 and the second distribution flow path 2310 are arranged in parallel, the distribution flow path 310 is located in an end portion. While the distribution flow path 310 includes the bend portions 340 on the first inner wall 331, the distribution flow path 310 prevents air bubbles from being pulled into the pressure chambers 113. That is, while there is a degree of freedom in the shape of the distribution flow path 310, the distribution flow path 310 can prevent air bubbles from being pulled into the pressure chambers 113. In the array in which the distribution flow path 310 and the second distribution flow path 2310 are arranged in parallel, the position of a flow path other than a flow path in the end portion is preferentially determined, and therefore, it is desirable that there should be a degree of freedom in the shape of the flow path located in the end portion. It is desirable that the flow path located in the end portion should be the distribution flow path 310.

As illustrated in FIG. 8A, in the array in which the distribution flow path 310 and the second distribution flow path 2310 are arranged in parallel, it is desirable that the second distribution flow path 2310 should be located on the first inner wall 331 (the inner wall including the bend portions 340) side of the distribution flow path 310. It is further desirable that the first inner wall 331 of the distribution flow path 310 and the fourth inner wall 334 of the second distribution flow path 2310 should be adjacent to each other.

Based on the above, the liquid discharge head 1000 according to the present exemplary embodiment can prevent air bubbles stagnant in a distribution flow path from being pulled into pressure chambers. Thus, it is possible to prevent the occurrence of a discharge failure.

### Reference Examples

More detailed reference examples of the liquid discharge apparatus 2000 are described.

### <Pressure Adjustment Method>

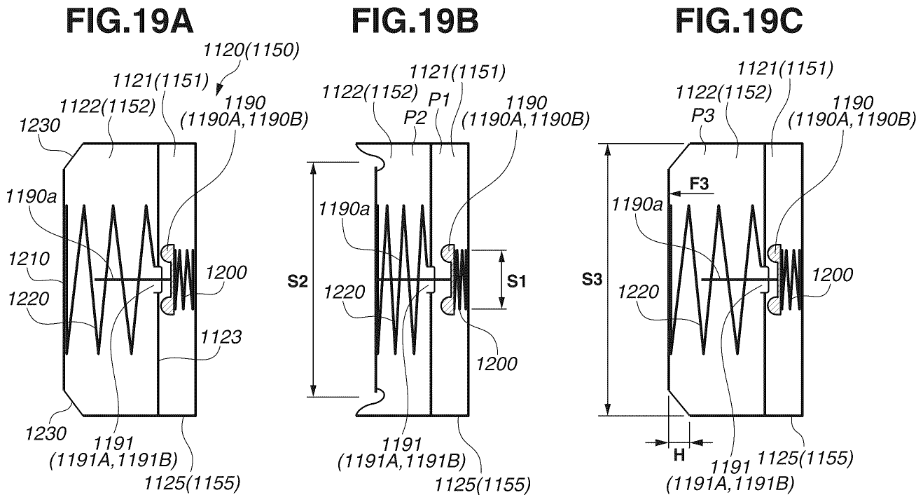

FIGS. 19A to 19C are diagrams illustrating examples of pressure adjustment methods. With reference to FIGS. 19A to 19C, the configurations and the actions of pressure adjustment methods (a first pressure adjustment method 1120 and a second pressure adjustment method 1150) built into the liquid discharge head 1000 are described in more detail. The first pressure adjustment method 1120 and the second pressure adjustment method 1150 have substantially the same configurations. Thus, the following description is given taking the first pressure adjustment method 1120 as an example. Regarding the second pressure adjustment method 1150, codes of portions corresponding to those of the first pressure adjustment method 1120 are merely written together in FIGS. 19A to 19C. In the case of the second pressure adjustment method 1150, a “first valve chamber 1121” is read as a “second valve chamber 1151”, and a “first pressure control chamber 1122” is read as a “second pressure control chamber 1152” in the following description.

The first pressure adjustment method 1120 includes a first valve chamber 1121 and a first pressure control chamber 1122 formed in a cylindrical housing 1125. The first valve chamber 1121 and the first pressure control chamber 1122 are divided from each other by a division wall 1123 provided in the cylindrical housing 1125. The first valve chamber 1121, however, communicates with the first pressure control chamber 1122 via a communication port 1191 formed in the division wall 1123. In the first valve chamber 1121, a valve 1190 that switches the communication and the interruption between the first valve chamber 1121 and the first pressure control chamber 1122 in the communication port 1191 is provided. The valve 1190 is held at a position opposed to the communication port 1191 by a valve spring 1200 and has a configuration in which the valve 1190 can come into close contact with the division wall 1123 by the biasing force of the valve spring 1200. The valve 1190 comes into close contact with the division wall 1123, whereby the distribution of ink through the communication port 1191 is interrupted. To increase the contact with the division wall 1123, it is desirable that a contact portion of the valve 1190 with the division wall 1123 should be formed of an elastic member. In a center portion of the valve 1190, a valve shaft 1190a to be inserted into the communication port 1191 is provided in a protruding manner. The valve shaft 1190a is pressed against the biasing force of the valve spring 1200, whereby the valve 1190 separates from the division wall 1123, and ink can be distributed through the communication port 1191. Hereinafter, the state where the distribution of ink through the communication port 1191 is interrupted by the valve 1190 is referred to as a “closed state”, and the state where ink can be distributed through the communication port 1191 is referred to as an “open state”.

An opening portion of the cylindrical housing 1125 is blocked by a flexible member 1230 and a pressure plate 1210. The first pressure control chamber 1122 is formed by the flexible member 1230, the pressure plate 1210, a peripheral wall of the housing 1125, and the division wall 1123. The pressure plate 1210 is configured to be displaced according to the displacement of the flexible member 1230. The materials of the pressure plate 1210 and the flexible member 1230 are not particularly limited. For example, the pressure plate 1210 can be composed of a resin-molded component, and the flexible member 1230 can be composed of a resin film. In this case, it is possible to fix the pressure plate 1210 to the flexible member 1230 by heat welding.

Between the pressure plate 1210 and the division wall 1123, a pressure adjustment spring 1220 (a biasing member) is provided. As illustrated in FIG. 19A, the pressure plate 1210 and the flexible member 1230 are biased by the biasing force of the pressure adjustment spring 1220 in the direction in which the inner volume of the first pressure control chamber 1122 increases. If the pressure in the first pressure control chamber 1122 decreases, the pressure plate 1210 and the flexible member 1230 are displaced against the pressure of the pressure adjustment spring 1220 in the direction in which the inner volume of the first pressure control chamber 1122 decreases. Then, if the inner volume of the first pressure control chamber 1122 decreases to a certain amount, the pressure plate 1210 abuts the valve shaft 1190a of the valve 1190. Then, if the inner volume of the first pressure control chamber 1122 further decreases, the valve 1190 moves together with the valve shaft 1190a against the biasing force of the valve spring 1200 and separates from the division wall 1123. Consequently, the communication port 1191 enters the open state (the state in FIG. 19B).

In the present exemplary embodiment, connection settings in the circulation path are made such that the pressure in the first valve chamber 1121 when the communication port 1191 is in the open state is higher than the pressure in the first pressure control chamber 1122. Consequently, if the communication port 1191 enters the open state, ink flows into the first pressure control chamber 1122 from the first valve chamber 1121. By the inflow of the ink, the flexible member 1230 and the pressure plate 1210 are displaced in the direction in which the inner volume of the first pressure control chamber 1122 increases. As a result, the pressure plate 1210 separates from the valve shaft 1190a of the valve 1190, and the valve 1190 comes into close contact with the division wall 1123 by the biasing force of the valve spring 1200. Consequently, the communication port 1191 enters the closed state (the state in FIG. 19C).

As described above, in the first pressure adjustment method 1120 according to the present exemplary embodiment, if the pressure in the first pressure control chamber 1122 decreases to a certain pressure force or less (e.g., the negative pressure in the first pressure control chamber 1122 becomes strong), ink flows into the first pressure control chamber 1122 from the first valve chamber 1121 through the communication port 1191. By the flow of the ink, the pressure in the first pressure control chamber 1122 is configured not to decrease any further. Thus, the first pressure control chamber 1122 is controlled to be maintained at a pressure in a certain range.

Next, the pressure in the first pressure control chamber 1122 is described in more detail.

A state is considered where, as described above, the flexible member 1230 and the pressure plate 1210 are displaced according to the pressure in the first pressure control chamber 1122, the pressure plate 1210 abuts the valve shaft 1190a, and the communication port 1191 is in the open state (the state in FIG. 19B). At this time, the relationships between forces acting on the pressure plate 1210 are represented by the following formula 1.

$$P 2 \times S 2 + F 2 + ( P 1 - P 2 ) \times S 1 + F 1 = 0 \qquad formula 1$$

Further, formula 1 is arranged regarding P2 as follows.

$$P 2 = - ( F 1 + F 2 + P 1 \times S 1 ) / ( S 2 - S 1 ) \qquad formula 2$$

P1: the pressure (gauge pressure) in the first valve chamber 1121
P2: the pressure (gauge pressure) in the first pressure control chamber 1122
F1: the spring force of the valve spring 1200
F2: the spring force of the pressure adjustment spring 1220
S1: the pressure reception area of the valve 1190
S2: the pressure reception area of the pressure plate 1210

Regarding the spring force F1 of the valve spring 1200 and the spring force F2 of the pressure adjustment spring 1220, the direction in which the valve 1190 and the pressure plate 1210 are pressed is a positive direction (the left direction in FIGS. 19A to 19C). The pressure P1 in the first valve chamber 1121 and the pressure P2 in the first pressure control chamber 1122 are configured so that the pressure P1 is in a relationship where P1≥P2.

The pressure P2 in the first pressure control chamber 1122 when the communication port 1191 enters the open state is determined by formula 2. If the communication port 1191 enters the open state, then according to the configuration for achieving the relationship where P1≥P2, ink flows into the first pressure control chamber 1122 from the first valve chamber 1121. As a result, the pressure P2 in the first pressure control chamber 1122 does not decrease any further, and the pressure P2 is maintained at a pressure in a certain range.

On the other hand, as illustrated in FIG. 19C, the relationships between forces acting on the pressure plate 1210 when the pressure plate 1210 is in a non-abutment state where the pressure plate 1210 does not abut the valve shaft 1190a, and the communication port 1191 is in the closed state are represented by formula 3.

$$P 3 \times S 3 + F 3 = 0 \qquad formula 3$$

Formula 3 is arranged regarding P3 as follows.

$$P 3 = - F 3 / S 3 \qquad formula 4$$

F3: the spring force of the pressure adjustment spring 1220 when the pressure plate 1210 and the valve shaft 1190a are in the non-abutment state
P3: the pressure (gauge pressure) of the first pressure control chamber 1122 when the pressure plate 1210 and the valve shaft 1190a are in the non-abutment state
S3: the pressure reception area of the pressure plate 1210 when the pressure plate 1210 and the valve 1190 are in the non-abutment state

FIG. 19C illustrates the state where the pressure plate 1210 and the flexible member 1230 are displaced in the right direction in FIG. 19C to the limit where the pressure plate 1210 and the flexible member 1230 can be displaced. According to the amounts of displacement of the pressure plate 1210 and the flexible member 1230 while being displaced to the state in FIG. 19C, the pressure P3 in the first pressure control chamber 1122, the spring force F3 of the pressure adjustment spring 1220, and the pressure reception area S3 of the pressure plate 1210 change. Specifically, when the pressure plate 1210 and the flexible member 1230 are located further in the left direction in FIGS. 19A to 19C than in FIG. 19C, the pressure reception area S3 of the pressure plate 1210 is small, and the spring force F3 of the pressure adjustment spring 1220 is great. As a result, based on the relationship of formula 4, the pressure P3 in the pressure control chamber 1122 becomes small. Thus, based on formulas 2 and 4, while the first pressure adjustment method 1120 changes from the state in FIG. 19B to the state in FIG. 19C, the pressure in the first pressure control chamber 1122 gradually increases (i.e., the negative pressure in the first pressure control chamber 1122 becomes weak and reaches a value that comes close to the positive pressure side). That is, the pressure plate 1210 and the flexible member 1230 are gradually displaced in the right direction from the state where the communication port 1191 is in the open state. Until the inner volume of the first pressure control chamber 1122 ultimately reaches the limit where the pressure plate 1210 and the flexible member 1230 can be displaced, the pressure in the first pressure control chamber 1122 gradually increases. That is, the negative pressure in the first pressure control chamber 1122 becomes weaker.

### <Circulation Pump>

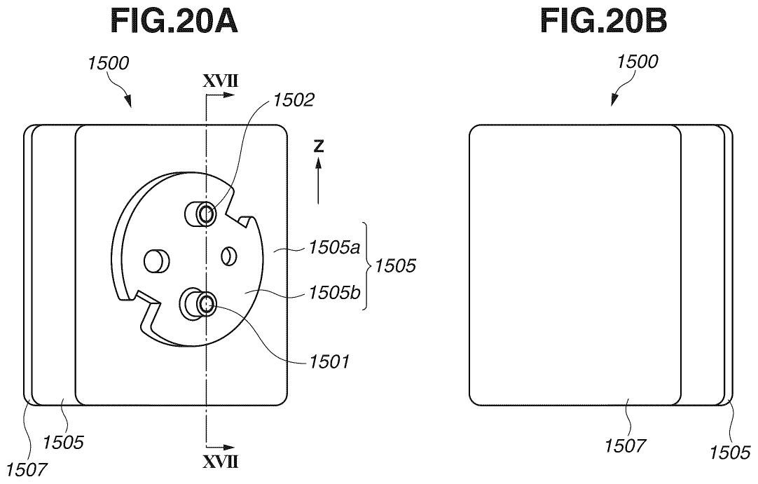

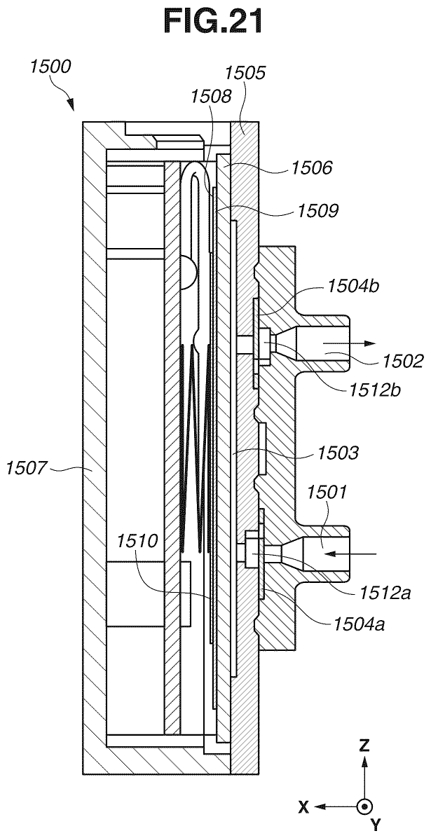

Next, with reference to FIGS. 20A, 20B, and 21, the configuration and the action of a circulation pump 1500 built into the liquid discharge head 1000 are described in detail.

FIGS. 20A and 20B are external perspective views of the circulation pump 1500. FIG. 20A is an external perspective view illustrating the front surface side of the circulation pump 1500. FIG. 20B is an external perspective view illustrating the back surface side of the circulation pump 1500. An outer shell of the circulation pump 1500 includes a pump housing 1505 and a cover 1507 fixed to the pump housing 1505. The pump housing 1505 includes a housing portion main body 1505a and a flow path connection member 1505b bonded and fixed to an outer surface of the housing portion main body 1505a. In the housing portion main body 1505a and the flow path connection member 1505b, pairs of through-holes communicating with each other are provided at two different positions. The pair of through-holes provided at one of the positions forms a pump supply hole 1501, and the pair of through-holes provided at the other position forms a pump ejection hole 1502. The pump supply hole 1501 is connected to a pump inlet flow path 1170 connected to the second pressure control chamber 1152, and the pump ejection hole 1502 is connected to a pump outlet flow path 1180 connected to the first pressure control chamber 1122. Ink supplied from the pump supply hole 1501 passes through a pump chamber 1503 (see FIG. 21) and is ejected from the pump ejection hole 1502.

FIG. 21 is a cross-sectional view of the circulation pump 1500 along XVII-XVII illustrated in FIG. 20A. A diaphragm 1506 is joined to an inner surface of the pump housing 1505, and a pump chamber 1503 is formed between the diaphragm 1506 and a recessed portion formed in the inner surface of the pump housing 1505. The pump chamber 1503 communicates with the pump supply hole 1501 and the pump ejection hole 1502 formed in the pump housing 1505. In an intermediate portion of the pump supply hole 1501, a check valve 1504a is provided. In an intermediate portion of the pump ejection hole 1502, a check valve 1504b is provided. Specifically, the check valve 1504a is placed so that a part of the check valve 1504a can move to the left in FIG. 21 in a space 1512a formed in the intermediate portion of the pump supply hole 1501. The check valve 1504b is placed so that a part of the check valve 1504b can move to the right in FIG. 21 in a space 1512b formed in the intermediate portion of the pump ejection hole 1502.

If the pump chamber 1503 is depressurized by the volume of the pump chamber 1503 increasing due to the displacement of the diaphragm 1506, the check valve 1504a separates from an opening of the pump supply hole 1501 in the space 1512a (i.e., moves to the left in FIG. 21). The check valve 1504a separates from the opening of the pump supply hole 1501 in the space 1512a, whereby the check valve 1504a enters an open state where ink can be distributed through the pump supply hole 1501. If the pump chamber 1503 is pressurized by the volume of the pump chamber 1503 decreasing due to the displacement of the diaphragm 1506, the check valve 1504a comes into close contact with a wall surface around the opening of the pump supply hole 1501. As a result, the check valve 1504a enters a closed state where the distribution of ink through the pump supply hole 1501 is interrupted.

On the other hand, if the pump chamber 1503 is depressurized, the check valve 1504b comes into close contact with a wall surface around an opening of the pump housing 1505, whereby the check valve 1504b enters a closed state where the distribution of ink through the pump ejection hole 1502 is interrupted. If the pump chamber 1503 is pressurized, the check valve 1504b separates from the opening of the pump housing 1505 and moves toward the space 1512b (i.e., moves to the right in FIG. 21), whereby ink can be distributed through the pump ejection hole 1502.

The material of each of the check valves 1504a and 1504b may be any material capable of deforming according to the pressure in the pump chamber 1503. For example, each of the check valves 1504a and 1504b can be formed of an elastic member such as ethylene-propylene-diene rubber (EPDM) or an elastomer, a film of polypropylene, or a thin plate. The present disclosure, however, is not limited to these.

As described above, the pump chamber 1503 is formed by joining the pump housing 1505 and the diaphragm 1506. Thus, the pressure in the pump chamber 1503 changes by the diaphragm 1506 deforming. For example, if the diaphragm 1506 is displaced toward the pump housing 1505 (displaced to the right side in FIG. 21) and the volume of the pump chamber 1503 decreases, the pressure in the pump chamber 1503 increases. Consequently, the check valve 1504b placed opposed to the pump ejection hole 1502 enters the open state, and ink in the pump chamber 1503 is ejected. At this time, the check valve 1504a placed opposed to the pump supply hole 1501 comes into close contact with the wall surface around the pump supply hole 1501. Thus, the backflow of ink from the pump chamber 1503 to the pump supply hole 1501 is prevented.

Conversely, if the diaphragm 1506 is displaced in the direction in which the pump chamber 1503 expands, the pressure in the pump chamber 1503 decreases. Consequently, the check valve 1504a placed opposed to the pump supply hole 1501 enters the open state, and ink is supplied to the pump chamber 1503. At this time, the check valve 1504b placed opposed to the pump ejection hole 1502 comes into close contact with the wall surface around the opening formed in the pump housing 1505 and blocks the opening. Thus, the backflow of ink from the pump ejection hole 1502 to the pump chamber 1503 is prevented.

As described above, in the circulation pump 1500, ink is suctioned and ejected by the diaphragm 1506 deforming and the pressure in the pump chamber 1503 changing. At this time, if bubbles are mixed into the pump chamber 1503, and even if the diaphragm 1506 is displaced, a change in the pressure in the pump chamber 1503 is small due to the expansion and contraction of the bubbles, and the amount of sending liquid decreases. Accordingly, the pump chamber 1503 is placed parallel to gravity, thereby making bubbles mixed into the pump chamber 1503 likely to be collected in an upper portion of the pump chamber 1503, and the pump ejection hole 1502 is placed above the center of the pump chamber 1503. Consequently, it is possible to improve the property of ejecting bubbles in the pump 1500 and stabilize the flow rate.

### <Flow of Ink in Liquid Discharge Head>

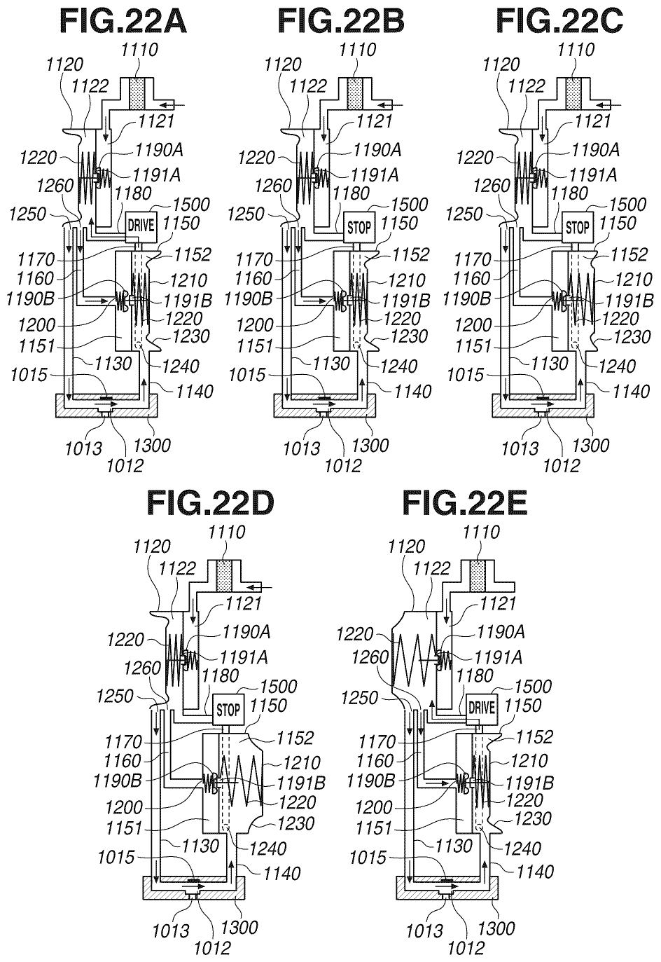

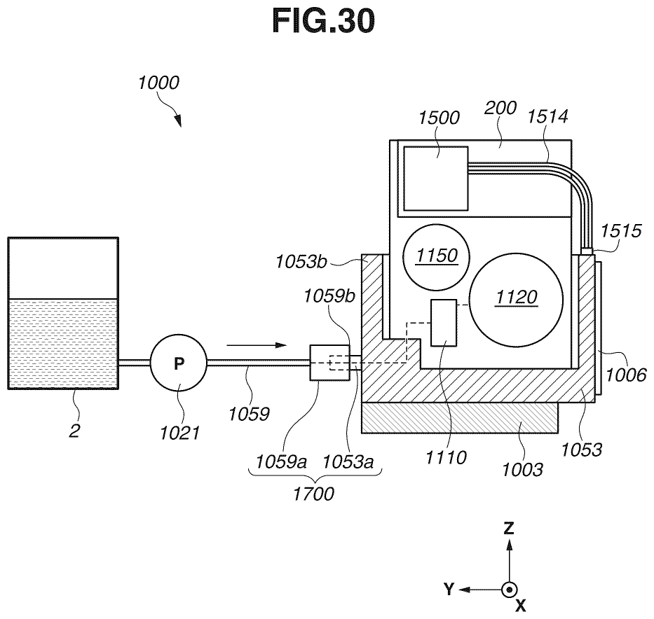

FIGS. 22A to 22E are diagrams illustrating the flow of ink in the liquid discharge head 1000. With reference to FIGS. 22A to 22E, the circulation of ink in the liquid discharge head 1000 is described. To describe the circulation path of ink more clearly, the relative positions of components (the first pressure adjustment method 1120, the second pressure adjustment method 1150, and the circulation pump 1500) in FIGS. 22A to 22E are simplified. The relative positions of other components are different from a configuration in FIG. 30. FIG. 22A schematically illustrates the flow of ink when a recording operation for performing recording by discharging ink from a discharge port 1013 is performed. An arrow in FIG. 22A indicates the flow of ink. In the present exemplary embodiment, when the recording operation is performed, both an external pump 1021 and the circulation pump 1500 start to be driven. The external pump 1021 and the circulation pump 1500 may be driven regardless of the recording operation. Alternatively, the external pump 1021 and the circulation pump 1500 may not be driven in conjunction with each other, and may be separately and independently driven.

During the recording operation, the circulation pump 1500 is in an on state (a driven state), and ink flowing out of the first pressure control chamber 1122 flows into a supply flow path 1130 and a bypass flow path 1160. The ink flowing into the supply flow path 1130 passes through a discharge module 1300, then flows into a collection flow path 1140, and then is supplied to the second pressure control chamber 1152.

On the other hand, the ink flowing into the bypass flow path 1160 from the first pressure control chamber 1122 flows into the second pressure control chamber 1152 through the second valve chamber 1151. The ink flowing into the second pressure control chamber 1152 passes through the pump inlet flow path 1170, the circulation pump 1500, and the pump outlet flow path 1180 and then flows into the first pressure control chamber 1122 again. At this time, the control pressure force of the first valve chamber 1121 is set to be higher than the control pressure force of the first pressure control chamber 1122 based on the relationship of formula 2. Thus, ink in the first pressure control chamber 1122 is supplied to the discharge module 1300 through the supply flow path 1130 without flowing into the first valve chamber 1121. The ink flowing into the discharge module 1300 passes through the collection flow path 1140, the second pressure control chamber 1152, the pump inlet flow path 1170, the circulation pump 1500, and the pump outlet flow path 1180 and flows into the first pressure control chamber 1122 again. Based on the above, the circulation of ink that is completed in the liquid discharge head 1000 is performed.

In the above circulation of ink, the circulation amount (the flow rate) of ink in the discharge module 1300 is determined based on the differential pressure between the control pressure forces of the first pressure control chamber 1122 and the second pressure control chamber 1152. Then, this differential pressure is set to achieve a circulation amount capable of preventing the thickening of ink near the discharge port 1013 in the discharge module 1300. Ink corresponding to ink consumed by the recording is supplied from an ink tank 2 to the first pressure control chamber 1122 through a filter 1110 and the first valve chamber 1121. A mechanism for supplying ink corresponding to consumed ink is described in detail. Ink decreases from the inside of the circulation path by an amount corresponding to ink consumed by the recording, whereby the pressure in the first pressure control chamber 1122 decreases. As a result, ink in the first pressure control chamber 1122 also decreases. According to the decrease in the ink in the first pressure control chamber 1122, the inner volume of the first pressure control chamber 1122 decreases. Due to the decrease in the inner volume of the first pressure control chamber 1122, a communication port 1191A enters an open state, and ink is supplied from the first valve chamber 1121 to the first pressure control chamber 1122. Pressure loss occurs in the ink to be supplied when the ink passes through the communication port 1191A from the first valve chamber 1121. The ink flows into the first pressure control chamber 1122, whereby the ink having a positive pressure switches to a negative pressure state. Then, the ink flows into the first pressure control chamber 1122 from the first valve chamber 1121, whereby the pressure in the first pressure control chamber 1122 increases. Thus, the inner volume of the first pressure control chamber 1122 increases, and the communication port 1191A enters a closed state. As described above, according to the consumption of ink, the communication port 1191A repeats the open state and the closed state. If ink is not consumed, the communication port 1191A is maintained in the closed state.

FIG. 22B schematically illustrates the flow of ink immediately after the recording operation ends and the circulation pump 1500 enters an off state (a stop state). At the time when the recording operation ends and the circulation pump 1500 enters the off state, the pressure in the first pressure control chamber 1122 and the pressure in the second pressure control chamber 1152 are both the control pressures during the recording operation. Thus, according to the differential pressure between the pressure in the first pressure control chamber 1122 and the pressure in the second pressure control chamber 1152, the movement of ink as illustrated in FIG. 22B occurs. Specifically, the flow of ink in which ink is supplied from the first pressure control chamber 1122 to the discharge module 1300 through the supply flow path 1130 and then reaches the second pressure control chamber 1152 through the collection flow path 1140 continues to occur. The flow of ink in which ink flows from the first pressure control chamber 1122, passes through the bypass flow path 1160 and the second valve chamber 1151, and reaches the second pressure control chamber 1152 also continues to occur.

An amount of ink corresponding to ink having moved from the first pressure control chamber 1122 to the second pressure control chamber 1152 by these flows of ink is supplied from the ink tank 2 to the first pressure control chamber 1122 through the filter 1110 and the first valve chamber 1121. Thus, the inner volume of the first pressure control chamber 1122 is maintained constant. Based on the relationship of formula 2, if the inner volume of the first pressure control chamber 1122 is constant, the spring force F1 of the valve spring 1200, the spring force F2 of the pressure adjustment spring 1220, the pressure reception area S1 of the valve 1190, and the pressure reception area S2 of the pressure plate 1210 are maintained constant. Thus, the pressure in the first pressure control chamber 1122 is determined according to a change in the pressure (gauge pressure) P1 in the first valve chamber 1121. Thus, if the pressure P1 in the first valve chamber 1121 does not change, the pressure P2 in the first pressure control chamber 1122 is maintained at the same pressure as the control pressure during the recording operation.

On the other hand, the pressure in the second pressure control chamber 1152 changes over time according to a change in the inner volume of the second pressure control chamber 1152 associated with the inflow of ink from the first pressure control chamber 1122. Specifically, while the first pressure adjustment method 1120 changes from the state in FIG. 22B to the state in FIG. 22C where a communication port 1191B enters a closed state and the second valve chamber 1151 and the second pressure control chamber 1152 enter a non-communication state, the pressure in the second pressure control chamber 1152 changes according to formula 2. Then, the pressure plate 1210 and the valve shaft 1190a enter a non-abutment state, and the communication port 1191B enters the closed state. Then, as illustrated in FIG. 22D, ink flows into the second pressure control chamber 1152 from the collection flow path 1140. By the inflow of the ink, the pressure plate 1210 and the flexible member 1230 are displaced. Until the inner volume of the second pressure control chamber 1152 reaches the maximum inner volume, the pressure in the second pressure control chamber 1152 changes, i.e., increases, according to formula 4.

In the state in FIG. 22C, the flow of ink in which ink flows from the first pressure control chamber 1122, passes through the bypass flow path 1160 and the second valve chamber 1151, and reaches the second pressure control chamber 1152 does not occur. Thus, only the flow of ink in which ink in the first pressure control chamber 1122 is supplied to the discharge module 1300 through the supply flow path 1130 and then reaches the second pressure control chamber 1152 through the collection flow path 1140 occurs. As described above, the movement of ink from the first pressure control chamber 1122 to the second pressure control chamber 1152 occurs according to the differential pressure between the pressure in the first pressure control chamber 1122 and the pressure in the second pressure control chamber 1152. Thus, if the pressure in the second pressure control chamber 1152 is equal to the pressure in the first pressure control chamber 1122, the movement of ink stops.

In the state where the pressure in the second pressure control chamber 1152 is equal to the pressure in the first pressure control chamber 1122, the second pressure control chamber 1152 expands to the state illustrated in FIG. 22D. If the second pressure control chamber 1152 expands as illustrated in FIG. 22D, a storage portion capable of storing ink is formed in the second pressure control chamber 1152. The first pressure adjustment method 1120 transitions from the stop of the circulation pump 1500 to the state in FIG. 22D in about one to two minutes, although this time can change according to the shapes and the sizes of the flow paths and the properties of ink. If the circulation pump 1500 is driven in the state illustrated in FIG. 22D where ink is stored in the storage portion, the ink in the storage portion is supplied to the first pressure control chamber 1122 by the circulation pump 1500. Consequently, as illustrated in FIG. 22E, the amount of ink in the first pressure control chamber 1122 increases, and the flexible member 1230 and the pressure plate 1210 are displaced in the expansion direction. Then, if the circulation pump 1500 continues to be driven, the state in the circulation path changes as illustrated in FIG. 22A.

In the above description, the state in FIG. 22A is described as an example when the recording operation is performed. Alternatively, as described above, ink may be circulated without the recording operation. Also in this case, the flow of ink as illustrated in FIGS. 22A to 22E occurs according to the driving and the stop of the circulation pump 1500.

As described above, in the present exemplary embodiment, an example is used where, if the circulation pump 1500 is driven and ink is circulated, the communication port 1191B in the second pressure adjustment method 1150 enters an open state, and if the circulation of ink stops, the communication port 1191B enters a closed state. The present disclosure, however, is not limited to this. The control pressure force may be set so that even if the circulation pump 1500 is driven and ink is circulated, the communication port 1191B in the second pressure adjustment method 1150 is in the closed state. This method is specifically described below with the role of the bypass flow path 1160.

The bypass flow path 1160 connecting the first pressure adjustment method 1120 and the second pressure adjustment method 1150 is provided to, for example, in a case where a negative pressure generated in the circulation path becomes stronger than a predetermined value, prevent the influence of the negative pressure on the discharge module 1300. The bypass flow path 1160 is provided to also supply ink from both the supply flow path 1130 and the collection flow path 1140 to a pressure chamber 1012.

First, an example is described where, in a case where the negative pressure becomes stronger than the predetermined value, the provision of the bypass flow path 1160 prevents the influence of the negative pressure on the discharge module 1300. For example, the property (e.g., the viscosity) of ink may change according to a change in the ambient temperature. If the viscosity of the ink changes, pressure loss in the circulation path also changes. For example, if the viscosity of the ink decreases, the pressure loss in the circulation path decreases. As a result, the flow rate of the circulation pump 1500 that is being driven at a constant driving amount increases, and the flow rate of ink flowing through the discharge module 1300 increases. On the other hand, the discharge module 1300 is maintained at a constant temperature by a temperature adjustment mechanism (not illustrated), and therefore, the viscosity of ink in the discharge module 1300 is maintained constant even if the ambient temperature changes. The viscosity of the ink in the discharge module 1300 does not change, whereas the flow rate of the ink flowing through the discharge module 1300 increases. As a result, a negative pressure in the discharge module 1300 increases due to flow resistance. If the negative pressure in the discharge module 1300 thus becomes stronger than a predetermined value, the meniscus of the discharge port 1013 may be destroyed. Thus, external air may be pulled into the circulation path, and ink may not be able to be normally discharged. Even if the meniscus is not destroyed, a negative pressure in the pressure chamber 1012 may become stronger than a predetermined value and influence the discharge of ink.

Thus, in the present exemplary embodiment, the bypass flow path 1160 is formed in the circulation path. By the provision of the bypass flow path, if the negative pressure becomes stronger than the predetermined value, ink also flows into the bypass flow path 1160. Thus, it is possible to maintain the pressure in the discharge module 1300 constant. Thus, for example, the communication port 1191B in the second pressure adjustment method 1150 may be configured with a control pressure force to maintain the closed state even in a case where the circulation pump 1500 is being driven. Then, the control pressure force of the second pressure adjustment method 1150 may be set so that the communication port 1191B in the second pressure adjustment method 1150 enters the open state in a case where the negative pressure becomes stronger than the predetermined value. That is, in a case where the circulation pump 1500 is being driven, the communication port 1191B may be in the closed state so long as the meniscus is not destroyed even by a change in the flow rate of the pump 1500 due to a change in the viscosity such as a change in the environment, or a predetermined negative pressure is maintained.

### <Configuration of Discharge Unit>

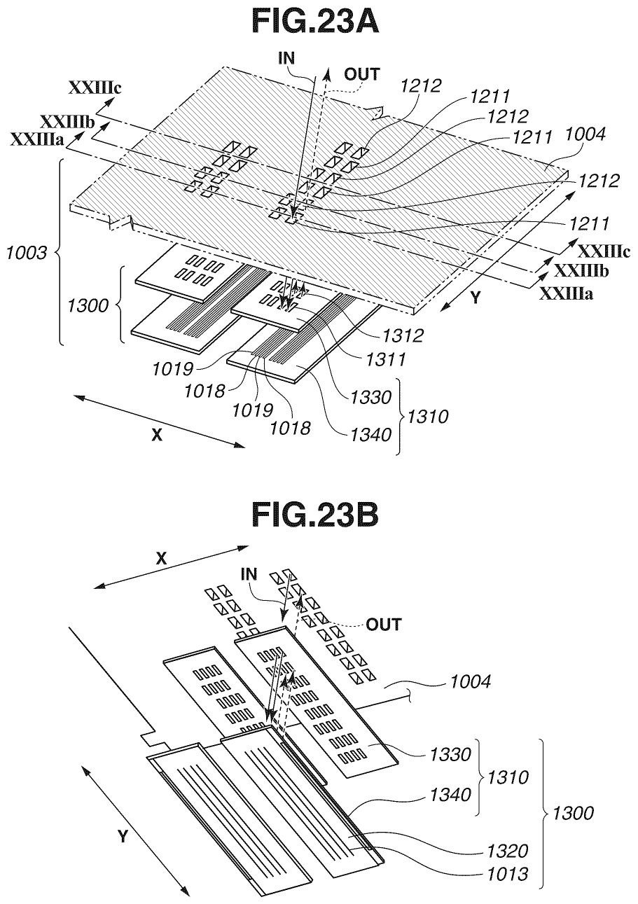

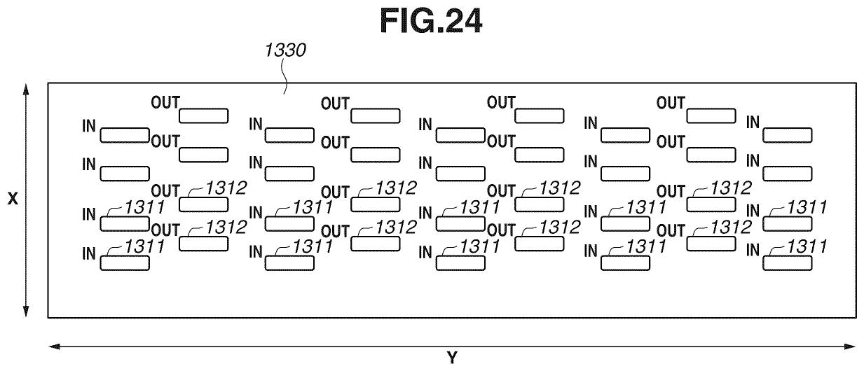

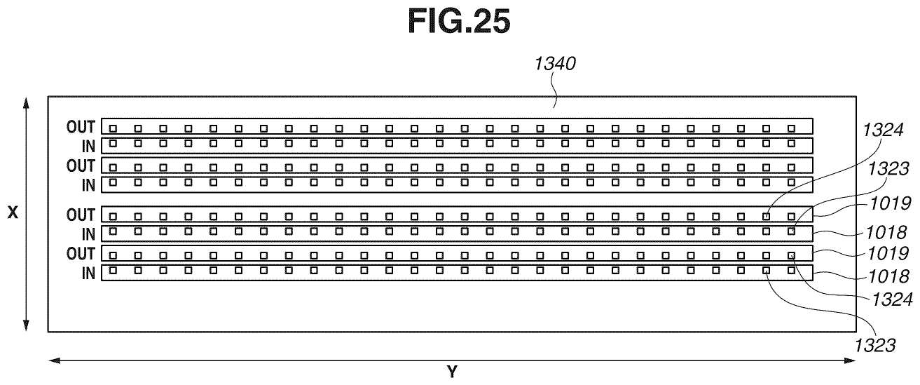

FIGS. 23A and 23B are schematic diagrams illustrating a circulation path corresponding to a single color of ink in a discharge unit 1003 according to the present exemplary embodiment. FIG. 23A is an exploded perspective view of the discharge unit 1003 when viewed from a first supporting member 1004 side. FIG. 23B is an exploded perspective view of the discharge unit 1003 when viewed from a discharge module 1300 side. Arrows represented as “IN” and “OUT” in FIGS. 23A and 23B indicate the flow of ink. Although the flow of ink corresponding to only a single color is described, the same applies to the flow of ink corresponding to another color. FIGS. 23A and 23B omit a second supporting member and electrical wiring members, and the second supporting member and the electrical wiring members are also omitted in the following description of the configuration of the discharge unit 1003. A discharge module 1300 includes a discharge element substrate 1340 and an opening plate 1330. FIG. 24 is a diagram illustrating the opening plate 1330. FIG. 25 is a diagram illustrating the discharge element substrate 1340.

Ink is supplied from the circulation unit 200 to the discharge unit 1003 through a joint member (not illustrated). A description is given of the path of ink from when the ink passes through the joint member to when the ink returns to the joint member.

The discharge module 1300 includes the discharge element substrate 1340 and the opening plate 1330 that are silicon substrates 1310, and further includes a discharge port formation member 1320. The discharge element substrate 1340, the opening plate 1330, and the discharge port formation member 1320 are joined together in an overlapping manner so that the flow paths of ink communicate with each other, thereby forming the discharge module 1300. The discharge module 1300 is supported by a first supporting member 1004. The discharge module 1300 is supported by the first supporting member 1004, thereby forming the discharge unit 1003. The discharge element substrate 1340 includes the discharge port formation member 1320, and the discharge port formation member 1320 includes a plurality of discharge port arrays in which a plurality of discharge ports 1013 forms an array. The discharge port formation member 1320 discharges from the discharge ports 1013 a part of ink supplied through ink flow paths in the discharge module 1300. Ink that is not discharged is collected through ink flow paths in the discharge module 1300.

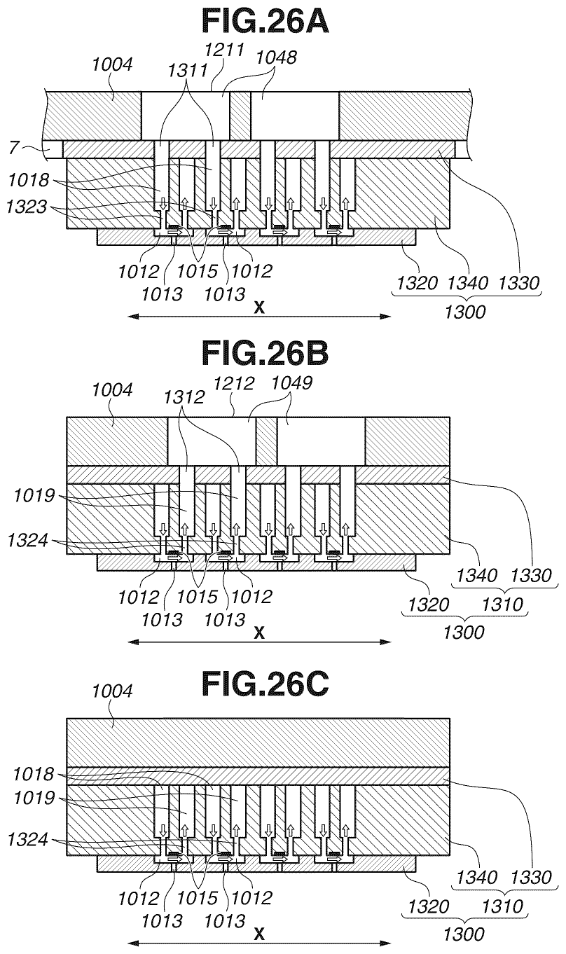

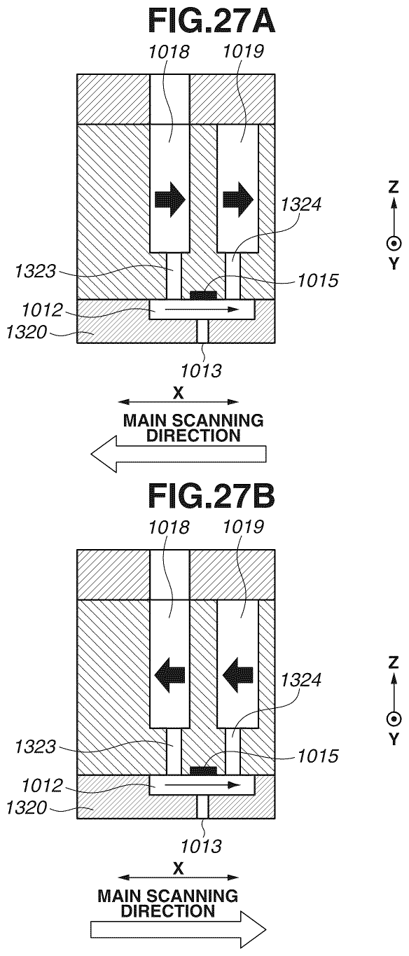

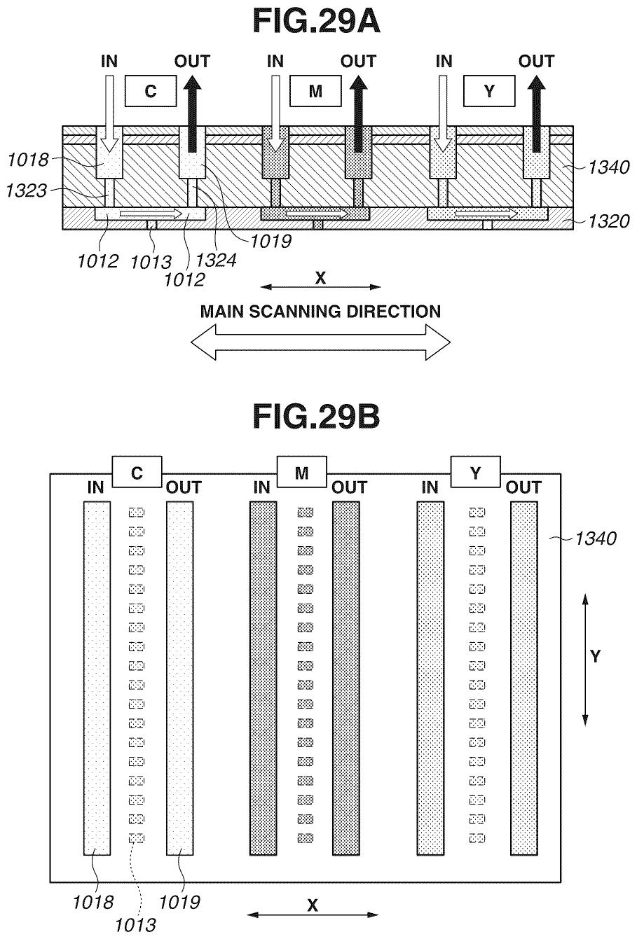

As illustrated in FIGS. 26A to 26C and FIGS. 27A and 27B, the opening plate 1330 includes a plurality of arranged ink supply ports 1311 and a plurality of arranged ink collection ports 1312. As illustrated in FIGS. 29A and 29B, the discharge element substrate 1340 includes a plurality of arranged supply connection flow paths 1323 and a plurality of arranged collection connection flow paths 1324. Further, the discharge element substrate 1340 includes a common supply flow path 1018 communicating with the plurality of supply connection flow paths 1323, and a common collection flow path 1019 communicating with the plurality of collection connection flow paths 1324. Ink flow paths in the discharge unit 1003 are formed by causing an ink supply flow path 1048 and an ink collection flow path 1049 provided in the first supporting member 1004 to communicate with flow paths provided in the discharge module 1300. Supporting member supply ports 1211 are cross-sectional openings forming the ink supply flow path 1048. Supporting member collection ports 1212 are cross-sectional openings forming the ink collection flow path 1049.

Ink to be supplied to the discharge unit 1003 is supplied from the circulation unit 200 side to the ink supply flow path 1048 of the first supporting member 1004. The ink flowing through the supporting member supply ports 1211 in the ink supply flow path 1048 is supplied to the common supply flow path 1018 of the discharge element substrate 1340 through the ink supply flow path 1048 and the ink supply ports 1311 of the opening plate 1330 and flows into the supply connection flow paths 1323. This is a supply side flow path. Then, the ink flows into the collection connection flow paths 1324 in a collection side flow path through pressure chambers 1012 of the discharge port formation member 1320. The details of the flow of ink in the pressure chambers 1012 will be described below.

In the collection side flow path, the ink flowing into the collection connection flow paths 1324 flows into the common collection flow path 1019. Then, the ink flows into the ink collection flow path 1049 of the first supporting member 1004 from the common collection flow path 1019 through the ink collection ports 1312 of the opening plate 1330 and is collected in the circulation unit 200 through the supporting member collection ports 1212.

A region where the ink supply ports 1311 and the ink collection ports 1312 are not present in the opening plate 1330 corresponds to a region for partitioning the supporting member supply ports 1211 and the supporting member collection ports 1212 in the first supporting member 1004. In this region, the first supporting member 1004 does not include openings, either. This region is used as a bonding region for bonding the discharge module 1300 and the first supporting member 1004.

In FIG. 24, in the opening plate 1330, a plurality of arrays of a plurality of openings arranged in the X-direction is provided in the Y-direction, and supply (IN) openings and collection (OUT) openings are alternately arranged in the Y-direction so that the supply (IN) openings and collection (OUT) openings are shifted by half a pitch in the X-direction. In FIG. 25, in the discharge element substrate 1340, common supply flow paths 1018 communicating with a plurality of supply connection flow paths 1323 arranged in the Y-direction and common collection flow paths 1019 communicating with a plurality of collection connection flow paths 1324 arranged in the Y-direction are alternately arranged in the X-direction. The common supply flow paths 1018 and the common collection flow paths 1019 are divided according to the types of ink. Further, the numbers of common supply flow paths 1018 and common collection flow paths 1019 to be placed are determined according to the numbers of discharge port arrays of the respective colors. The numbers of supply connection flow paths 1323 and collection connection flow paths 1324 to be placed also correspond to the discharge ports 1013. The supply connection flow paths 1323 and the collection connection flow paths 1324 may not necessarily correspond to the discharge ports 1013 on a one-on-one basis, and a single supply connection flow path 1323 and a single collection connection flow path 1324 may correspond to a plurality of discharge ports 1013.

The opening plate 1330 and the discharge element substrate 1340 as described above are joined together in an overlapping manner so that the flow paths of ink communicate with each other, thereby forming the discharge module 1300. The discharge module 1300 is supported by the first supporting member 1004. This forms ink flow paths including supply flow paths and collection flow paths as described above.

FIGS. 26A to 26C are cross-sectional views illustrating the flow of ink in different portions of the discharge unit 1003. FIG. 26A is a cross section along XXIIIa-XXIIIa illustrated in FIG. 23A and illustrates a cross section of a portion of the discharge unit 1003 where the ink supply flow path 1048 and the ink supply ports 1311 communicate with each other. FIG. 26B is a cross section along XXIIIb-XXIIIb illustrated in FIG. 23A and illustrates a cross section of a portion of the discharge unit 1003 where the ink collection flow path 1049 and the ink collection ports 1312 communicate with each other. FIG. 26C is a cross section along XXIIIc-XXIIIc illustrated in FIG. 23A and illustrates a cross section of a portion where the ink supply ports 1311 and the ink collection ports 1312 do not communicate with flow paths of the first supporting member 1004.

In a supply flow path in which ink is supplied, as illustrated in FIG. 26A, ink is supplied from a portion where the ink supply flow path 1048 of the first supporting member 1004 and the ink supply ports 1311 of the opening plate 1330 overlap and communicate with each other. In a collection flow path in which ink is collected, as illustrated in FIG. 26B, ink is collected from a portion where the ink collection flow path 1049 of the first supporting member 1004 and the ink collection ports 1312 of the opening plate 1330 overlap and communicate with each other. As illustrated in FIG. 26C, the discharge unit 1003 also includes a region where openings are not partially provided in the opening plate 1330. In this region, ink is not supplied and collected between the discharge element substrate 1340 and the first supporting member 1004. Ink is supplied in a region where the ink supply ports 1311 are provided as illustrated in FIG. 26A, and ink is collected in a region where the ink collection ports 1312 are provided as illustrated in FIG. 26B. Although in the present exemplary embodiment, a description has been given using as an example a configuration in which the opening plate 1330 is used, a form may be employed in which the opening plate 1330 is not used. For example, a configuration may be employed in which flow paths corresponding to the ink supply flow path 1048 and the ink collection flow path 1049 are formed in the first supporting member 1004, and the discharge element substrate 1340 is joined to the first supporting member 1004.

FIGS. 27A and 27B are cross-sectional views illustrating the vicinity of a discharge port 1013 in the discharge module 1300. Thick arrows illustrated in the common supply flow path 1018 and the common collection flow path 1019 in FIGS. 27A and 27B indicate the fluctuation of ink in a form in which the serial liquid discharge apparatus 2000 is used. Ink supplied to a pressure chamber 1012 through the common supply flow path 1018 and a supply connection flow path 1323 is discharged from the discharge port 1013 by driving a discharge element 1015. In a case where the discharge element 1015 is not driven, ink is collected in the common collection flow path 1019 from the pressure chamber 1012 through a collection connection flow path 1324 that is a collection flow path.

In the form in which the serial liquid discharge apparatus 2000 is used, in a case where ink circulating as described above is discharged, the discharge of the ink is influenced by the fluctuation of ink in ink flow paths by the main scanning of the liquid discharge head 1000. Specifically, the influence of the fluctuation of ink in the ink flow paths may appear as a difference in the discharge amount of ink or a shift in the discharge direction of ink.

Accordingly, a configuration is employed in which the common supply flow path 1018 and the common collection flow path 1019 according to the present exemplary embodiment both extend in the Y-direction in the cross sections illustrated in FIGS. 27A and 27B, and also extend in the Z-direction perpendicular to the X-direction, which is the main scanning direction. With this configuration, it is possible to make the flow path widths in the main scanning direction of the common supply flow path 1018 and the common collection flow path 1019 small. The flow path widths in the main scanning direction of the common supply flow path 1018 and the common collection flow path 1019 are made small, thereby decreasing the fluctuation of ink due to inertial forces (the black thick arrows in Fig. FIGS. 27A and 27B) applied in a direction opposite to the main scanning direction and acting on ink in the common supply flow path 1018 and the common collection flow path 1019 during the main scanning. Consequently, it is possible to reduce the influence of the fluctuation of ink on the discharge of ink. The common supply flow path 1018 and the common collection flow path 1019 extend in the Z-direction, thereby increasing the cross-sectional areas and reducing pressure loss in the flow paths.

As described above, a configuration is employed in which the flow path widths in the main scanning direction of the common supply flow path 1018 and the common collection flow path 1019 are made small, thereby decreasing the fluctuation of ink in the common supply flow path 1018 and the common collection flow path 1019 during the main scanning. It is, however, not that the fluctuation disappears. Accordingly, in the present exemplary embodiment, to prevent a difference in the discharge of each type of ink that can still occur even by the decreased fluctuation, a configuration is employed in which the common supply flow path 1018 and the common collection flow path 1019 are placed at positions overlapping each other in the X-direction.

As described above, in the present exemplary embodiment, the supply connection flow path 1323 and the collection connection flow path 1324 are provided corresponding to the discharge port 1013 and have a correspondence relationship where the supply connection flow path 1323 and the collection connection flow path 1324 are arranged next to each other in the X-direction across the discharge port 1013. Thus, if there is a portion where the common supply flow path 1018 and the common collection flow path 1019 do not overlap each other in the X-direction, and the correspondence relationship between the supply connection flow path 1323 and the collection connection flow path 1324 in the X-direction breaks down, this influences the flow and the discharge of ink in the X-direction in the pressure chamber 1012. The influence of the fluctuation of ink is added to this, whereby the discharge of ink with respect to each discharge port 1013 may be further influenced.

Thus, the common supply flow path 1018 and the common collection flow path 1019 are placed at positions overlapping each other in the X-direction. Consequently, the fluctuation of ink during the main scanning in the common supply flow path 1018 and the common collection flow path 1019 is almost equivalent at any positions in the Y-direction in which the discharge ports 1013 are arranged. As a result, a pressure difference between the common supply flow path 1018 side and the common collection flow path 1019 side that occurs in the pressure chamber 1012 does not greatly vary. Thus, it is possible to stably discharge ink.

In some liquid discharge head that circulates ink, a flow path that supplies ink to the liquid discharge head and a flow path that collects the ink are formed by the same flow path. In the present exemplary embodiment, however, the common supply flow path 1018 and the common collection flow path 1019 are different flow paths. Then, the supply connection flow path 1323 and the pressure chamber 1012 communicate with each other, the pressure chamber 1012 and the collection connection flow path 1324 communicate with each other, and ink is discharged from the discharge port 1013 of the pressure chamber 1012. That is, a configuration is employed in which the pressure chamber 1012 that is a path connecting the supply connection flow path 1323 and the collection connection flow path 1324 includes the discharge port 1013. Thus, the flow of ink from the supply connection flow path 1323 side to the collection connection flow path 1324 side occurs in the pressure chamber 1012, and ink in the pressure chamber 1012 is efficiently circulated. The ink in the pressure chamber 1012 is efficiently circulated, whereby it is possible to maintain the ink in the pressure chamber 1012, which is likely to be influenced by the evaporation of ink from the discharge port 1013, in a fresh state.

Since two flow paths, namely the common supply flow path 1018 and the common collection flow path 1019, communicate with the pressure chamber 1012, if it is necessary to discharge ink at a high flow rate, it is also possible to supply ink from both flow paths. That is, the configuration of the present exemplary embodiment has the advantage that it is possible to not only efficiently circulate ink, but also handle the discharge of ink at a high flow rate, over a configuration in which the supply and the collection of ink are configured with only a single flow path.

If the common supply flow path 1018 and the common collection flow path 1019 are placed at close positions in the X-direction, the influence of the fluctuation of ink is less likely to occur. It is desirable that the distance between the flow paths should be 75 μm (micrometers) to 100 μm.

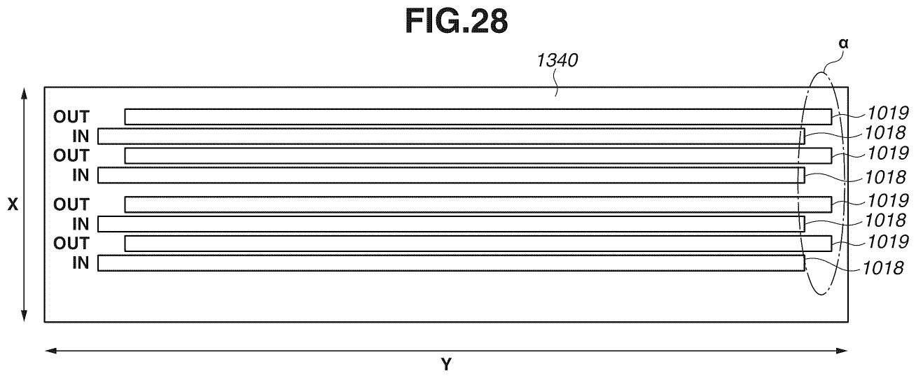

FIG. 28 is a diagram illustrating the discharge element substrate 1340 in a comparative example. FIG. 28 omits the supply connection flow paths 1323 and the collection connection flow paths 1324. Since ink having received thermal energy from the discharge element 1015 in the pressure chamber 1012 flows into the common collection flow paths 1019, ink having a high temperature relative to the temperature of ink in the common supply flow path 1018 flows. At this time, in the comparative example, there is a portion where only common collection flow paths 1019 are present in a part in the X-direction of the discharge element substrate 1340 as in a portion a surrounded by a dashed-dotted line in FIG. 28. In this case, the temperature may locally rise in this portion, temperature unevenness may occur in the discharge module 1300, and this may influence the discharge of ink.

In the common supply flow path 1018, ink having a low temperature relative to the temperature of ink in the common collection flow path 1019 flows. Thus, if the common supply flow path 1018 and the common collection flow path 1019 are adjacent to each other, the temperatures of parts of ink cancel out each other in the common supply flow path 1018 and the common collection flow path 1019 near the position where the common supply flow path 1018 and the common collection flow path 1019 are adjacent to each other. This reduces a temperature rise. Thus, it is desirable that the common supply flow path 1018 and the common collection flow path 1019 should have substantially the same lengths, be present at positions overlapping each other in X-direction, and be adjacent to each other.

FIGS. 29A and 29B are diagrams illustrating the flow path configuration of the liquid discharge head 1000 corresponding to ink of three colors, namely cyan (C), magenta (M), and yellow (Y). As illustrated in FIG. 29A, a circulation flow path is provided with respect to each type of ink in the liquid discharge head 1000. A pressure chamber 1012 is provided along the X-direction, which is the main scanning direction of the liquid discharge head 1000. As illustrated in FIG. 29B, a common supply flow path 1018 and a common collection flow path 1019 are provided along a discharge port array in which discharge ports 1013 are arranged, and the common supply flow path 1018 and the common collection flow path 1019 are provided extending in the Y-direction across the discharge port array.

### <Connection Between Main Body Portion and Liquid Discharge Head>

FIG. 30 is a general configuration diagram illustrating in more detail the connection state of an ink tank 2 and an external pump 1021 provided in a main body portion of the liquid discharge apparatus 2000 according to the present exemplary embodiment and a liquid discharge head 1000, and the placement of a circulation pump 1500. The liquid discharge apparatus 2000 according to the present exemplary embodiment has a configuration in which only the liquid discharge head 1000 can be easily replaced when a defect occurs in the liquid discharge head 1000. Specifically, the liquid discharge apparatus 2000 includes a liquid connection portion 1700 that enables an ink supply tube 1059 connected to the external pump 1021 and the liquid discharge head 1000 to be easily connected to and detached from each other. Consequently. only the liquid discharge head 1000 can be easily attached to and detached from the liquid discharge apparatus 2000.

As illustrated in FIG. 30, the liquid connection portion 1700 includes a liquid connector insertion opening 1053a provided in a protruding manner in a head housing 1053 of the liquid discharge head 1000, and a cylindrical liquid connector 1059a into which the liquid connector insertion opening 1053a can be inserted. The liquid connector insertion opening 1053a is fluidically connected to an ink supply flow path formed in the liquid discharge head 1000 and is connected to a first pressure adjustment method 1120 via a filter 1110. The liquid connector 1059a is provided at an end of the ink supply tube 1059 connected to the external pump 1021 that supplies ink in the ink tank 2 in a pressurized manner to the liquid discharge head 1000.

As described above, in the liquid discharge head 1000 illustrated in FIG. 30, it is possible to easily perform the work of attaching and detaching the liquid discharge head 1000 and the work of replacing the liquid discharge head 1000, using the liquid connection portion 1700. If, however, the sealing properties of the liquid connector insertion opening 1053a and the liquid connector 1059a decrease, ink supplied in a pressurized manner from the external pump 1021 may leak from the liquid connection portion 1700. If the leaked ink becomes attached to the circulation pump 1500, a defect may occur in an electric system. Accordingly, in the present exemplary embodiment, the circulation pump 1500 is placed as follows.

### <Placement of Circulation Pump>

As illustrated in FIG. 30, in the present exemplary embodiment, to prevent ink leaked from the liquid connection portion 1700 from becoming attached to the circulation pump 1500, the circulation pump 1500 is placed above the liquid connection portion 1700 in the direction of gravity. That is, the circulation pump 1500 is placed above the liquid connector insertion opening 1053a, which is a liquid introduction port of the liquid discharge head 1000, in the direction of gravity. Further, the circulation pump 1500 is placed at a position where the circulation pump 1500 is not in contact with the members forming the liquid connection portion 1700. Consequently, even if ink leaks from the liquid connection portion 1700, the ink flows in the horizontal direction, which is the opening direction of the liquid connector 1059a, or downward in the direction of gravity. Thus, it is possible to prevent the ink from reaching the circulation pump 1500 above in the direction of gravity. The circulation pump 1500 is also placed at a position away from the liquid connection portion 1700. This also reduces the possibility that the ink flows down members and reaches the circulation pump 1500.

An electric connection portion 1515 electrically connecting the circulation pump 1500 and an electrical contact substrate 1006 via a flexible wiring member 1514 is also provided above the liquid connection portion 1700 in the direction of gravity. Thus, it is possible to reduce the possibility that the liquid connection portion 1700 causes an electrical trouble due to ink.

In the present exemplary embodiment, a wall portion 1053b of the head housing 1053 is provided. Thus, even if ink spouts from an opening 1059b of the liquid connection portion 1700, it is possible to block the ink and reduce the possibility that the ink reaches the circulation pump 1500 or the electric connection portion 1515.

According to the present disclosure, it is possible to provide a liquid discharge head that includes a distribution flow path preventing air bubbles from being pulled into pressure chambers and prevents the occurrence of a discharge failure.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Applications No. 2023-195027, filed Nov. 16, 2023, and No. 2024-145896, filed Aug. 27, 2024, which are hereby incorporated by reference herein in their entirety.

What is claimed is:

1. A liquid discharge head comprising:
a discharge element substrate including a plurality of discharge port arrays in which a plurality of discharge ports configured to discharge liquid is arranged, a discharge element configured to generate a pressure for discharging liquid from the discharge ports, and a plurality of pressure chambers where a pressure generated by driving the discharge element acts on liquid; and
a supporting member in which first distribution flow paths, each configured to distribute liquid to the plurality of pressure chambers corresponding to the plurality of discharge port arrays, is formed, the supporting member supporting the discharge element substrate,
wherein the first distribution flow paths each include a first opening located on a discharge element substrate side, and a second opening located on an opposite side of the first opening,
wherein, in a predetermined direction, an opening width of the first opening is larger than an opening width of the second opening, and a center of the opening width of the second opening is biased to one side with respect to a center of the opening width of the first opening,
wherein at least one bend portion is formed on an inner wall of the first distribution flow paths located on the one side, and
wherein, in a use state of the liquid discharge head, a bend portion closest to the first opening among the at least one bend portion is located on a first opening side of a center portion of the first distribution flow paths in a vertical direction.

2. The liquid discharge head according to claim 1,
wherein the inner wall of the first distribution flow paths including the at least one bend portion includes a first portion and a second portion, each extending in the vertical direction, and
wherein the at least one bend portion is located between the first portion and the second portion.

3. The liquid discharge head according to claim 2,
wherein the inner wall of the distribution flow path includes two of the at least one bend portion, and
wherein the inner wall of the distribution flow path includes a third portion connecting the first portion and the second portion via the two bend portions.

4. The liquid discharge head according to claim 3, wherein an angle between the predetermined direction and the third portion is 30° or more.

5. The liquid discharge head according to claim 1, wherein the discharge port arrays extend along a direction substantially orthogonal to the predetermined direction.

6. The liquid discharge head according to claim 1, further comprising:
a plurality of supply flow paths configured to supply liquid to the plurality of pressure chambers; and
a plurality of collection flow paths configured to collect liquid from the plurality of pressure chambers,
wherein the first distribution flow paths are connected to the plurality of pressure chambers via the plurality of supply flow paths.

7. The liquid discharge head according to claim 6, further comprising a pump configured to circulate liquid from the plurality of supply flow paths to the plurality of collection flow paths.

8. The liquid discharge head according to claim 6,
wherein the supporting member includes second distribution flow paths, each configured to distribute liquid to a plurality of pressure chambers corresponding to discharge port arrays different from the first distribution flow paths,
wherein the first distribution flow paths and the second distribution flow paths are arranged in parallel in the predetermined direction,
wherein the second distribution flow paths each include a third opening located on the discharge element substrate side, and a fourth opening located on an opposite side of the third opening,
wherein, in the predetermined direction, an opening width of the third opening is larger than an opening width of the fourth opening, and a center of the opening width of the fourth opening is biased to the one side with respect to a center of the opening width of the third opening, and
wherein the at least one bend portion is not formed on an inner wall of the second distribution flow paths located on the one side.

9. The liquid discharge head according to claim 7,
wherein the supporting member includes first aggregation flow paths, each configured to aggregate liquid from the plurality of pressure chambers through the plurality of collection flow paths, and
wherein the first distribution flow paths and the first aggregation flow paths are alternately arranged in parallel along a direction intersecting the predetermined direction.

10. The liquid discharge head according to claim 9,
wherein each of the first aggregation flow paths includes a fifth opening located on the discharge element substrate side, and a sixth opening located on an opposite side of the fifth opening,
wherein, in the predetermined direction, an opening width of the fifth opening is larger than an opening width of the sixth opening, and a center of the opening width of the sixth opening is shifted to the other side on an opposite side of the one side with respect to a center of the opening width of the fifth opening,
wherein at least one second bend portion is formed on an inner wall of the first aggregation flow paths located on the other side, and
wherein, in the use state of the liquid discharge head, a second bend portion closest to the fifth opening among the at least one second bend portion is located on a sixth opening side of a center portion of the first aggregation flow paths in the vertical direction.

11. The liquid discharge head according to claim 10,
wherein the supporting member includes second aggregation flow paths, each configured to aggregate liquid from a plurality of the pressure chambers corresponding to discharge port arrays different from the first aggregation flow paths,
wherein the first aggregation flow paths and the second aggregation flow paths are arranged in parallel in the predetermined direction,
wherein the second aggregation flow paths each include a seventh opening located on the discharge element substrate side, and an eighth opening located on the opposite side of the seventh opening,
wherein in the predetermined direction, an opening width of the seventh opening is larger than an opening width of the eighth opening, and a center of the opening width of the eighth opening is biased to the other side with respect to a center of the opening width of the seventh opening, and
wherein the at least one second bend portion is not formed on an inner wall of the second aggregation flow paths located on the other side.

12. The liquid discharge head according to claim 8, wherein the distribution flow path is located in an end portion of an array in which the first distribution flow paths and the second distribution flow paths are arranged in parallel.

13. The liquid discharge head according to claim 12, wherein the second distribution flow path is located on the one side of the first distribution flow paths.

14. A liquid discharge head comprising:
a discharge element substrate including a plurality of discharge port arrays in which a plurality of discharge ports configured to discharge liquid is arranged, a discharge element configured to generate a pressure for discharging liquid from the discharge ports, and a plurality of pressure chambers where a pressure generated by driving the discharge element acts on liquid; and
a supporting member in which first distribution flow paths, each configured to distribute liquid to the plurality of pressure chambers corresponding to the plurality of discharge port arrays, is formed, the supporting member supporting the discharge element substrate,
wherein the first distribution flow paths each include a first opening located on a discharge element substrate side, and a second opening formed on an opposite side of the first opening,
wherein, in a predetermined direction, an opening width of the first opening is larger than an opening width of the second opening, and a center of the opening width of the second opening is biased to one side with respect to a center of the opening width of the first opening,
wherein at least one bend portion is formed on an inner wall of the first distribution flow paths located on the one side, and
wherein, in a use state of the liquid discharge head, a bend portion closest to the first opening among the at least one bend portion is located on a second opening side of a center portion of the first distribution flow paths in a vertical direction.

15. The liquid discharge head according to claim 14, wherein the discharge port arrays extend along a direction substantially orthogonal to the predetermined direction.

16. The liquid discharge head according to claim 15,
wherein the supporting member includes second distribution flow paths, each configured to distribute liquid to a plurality of pressure chambers corresponding to discharge port arrays different from the first distribution flow paths,
wherein the first distribution flow paths and the second distribution flow paths are arranged in parallel in the predetermined direction,
wherein the second distribution flow paths includes a third opening located on the discharge element substrate side, and a fourth opening located on the opposite side of the third opening,
wherein, in the predetermined direction, an opening width of the third opening is larger than an opening width of the fourth opening, and a center of the opening width of the fourth opening is biased to the one side with respect to a center of the opening width of the third opening, and
wherein the at least one bend portion is not formed on an inner wall of the second distribution flow paths located on the one side.

17. The liquid discharge head according to claim 14, further comprising:
a plurality of supply flow paths configured to supply liquid to the plurality of pressure chambers; and
a plurality of collection flow paths configured to collect liquid from the plurality of pressure chambers,
wherein the supporting member includes aggregation flow paths, each configured to aggregate liquid from the plurality of pressure chambers through the plurality of collection flow paths,
wherein the first distribution flow paths is connected to the plurality of pressure chambers via the plurality of supply flow paths, and
wherein the first distribution flow paths and the aggregation flow paths are alternately arranged in parallel along a direction intersecting the predetermined direction.
